(19) United States
(12) Patent Application Publication
(10) Pub. No.: US 2026/0116092 A1
(43) Pub. Date: Apr. 30, 2026

(54) PRINTING APPARATUS AND CONTROL METHOD

(71) Applicant: CANON KABUSHIKI KAISHA, Tokyo (JP)

(72) Inventors: KEITA ISHIMI, Kanagawa (JP); AYUKO ISHII, Kanagawa (JP); MASATAKA KATO, Kanagawa (JP); HIDEHIKO KANDA, Kanagawa (JP); JUMPEI JOGO, Tokyo (JP); YUMI SHIMOKODACHI, Kanagawa (JP); TAKAAKI SHIMA, Tokyo (JP)

(21) Appl. No.: 19/368,529

(22) Filed: Oct. 24, 2025

(30) Foreign Application Priority Data
Oct. 25, 2024 (JP) 2024-188386
Jun. 30, 2025 (JP) 2025-110754

(51) Int. Cl. B41J 11/00; B41J 2/21; B41J 15/04

(52) U.S. Cl. CPC B41J 11/00222; B41J 2/2114; B41J 15/048

(57) ABSTRACT

A printing apparatus includes: a conveyance unit configured to convey roll sheet; a printing unit configured to print an image; a drying unit provided downstream of the printing unit in a conveyance direction; and a control unit configured to execute a second print job after a first print job is completed. The control unit preliminarily conveys the roll sheet in the conveyance direction after the first print job is completed. The control unit reversely conveys the roll sheet in a direction opposite to the conveyance direction in a case where, during the preliminary conveyance, a temperature of a region of the roll sheet exposed to heat from the drying unit meets a predetermined condition for executing the second print job.

### BACKGROUND

### Field of the Technology

The present disclosure relates to a printing apparatus and a control method.

### Description of the Related Art

It is generally known that, in a printing apparatus provided with a drying device for heating and drying roll sheet, in a case where conveyance of the roll sheet is stopped for an extended period of time, the heated portion of the roll sheet can be overheated and damaged.

Japanese Patent Laid-Open No. 2021-70320 discloses a printing apparatus in which roll sheet is preheated to a preheating temperature, and then heated to a printing temperature that is equal to or higher than the preheating temperature, after the temperature of a heating device reaches a predetermined temperature. The printing apparatus of Japanese Patent Laid-Open No. 2021-70320 mitigates sudden temperature changes in the roll sheet, thereby suppressing damage to the roll sheet.

### SUMMARY

It is an object of the present disclosure to provide a printing apparatus that allows for appropriate use of roll sheet.

A printing apparatus includes: a conveyance unit configured to convey roll sheet in a conveyance direction; a printing unit configured to print an image by ejecting a liquid onto the roll sheet conveyed by the conveyance unit; a drying unit provided downstream of the printing unit in the conveyance direction and configured to heat and dry a region of the roll sheet where the image is printed by the printing unit; and a control unit configured to control driving of the conveyance unit, driving of the printing unit, and driving of the drying unit to execute a second print job after a first print job is completed, wherein the control unit preliminarily conveys the roll sheet in the conveyance direction after the first print job is completed, and reversely conveys the roll sheet in a direction opposite to the conveyance direction in a case where, during the preliminary conveyance, a temperature of the region of the roll sheet exposed to heat from the drying unit meets a predetermined condition for executing the second print job.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a hardware configuration example applicable to an embodiment;

FIG. 2 is a cross-sectional view illustrating an example of a conveyance path applicable to the embodiment;

FIG. 3 is a block diagram illustrating a software configuration example applicable to the embodiment;

FIG. 4 is a diagram illustrating an example of print medium information applicable to the embodiment;

FIG. 5 is a flowchart illustrating a flow of conveyance control applicable to the embodiment;

FIG. 6 is a flowchart illustrating a subroutine of S503;

FIG. 7 is a flowchart illustrating a subroutine of S504;

FIG. 8 is an external perspective view of a printing apparatus according to an embodiment;

FIG. 9 is a diagram illustrating an example of a print head and a nozzle group according to the embodiment;

FIG. 10 is a block diagram illustrating a configuration example of a print control system according to the embodiment;

FIG. 11 is a schematic cross-sectional view of a drying configuration according to the embodiment;

FIG. 12 is a flowchart illustrating an example of damage control according to the embodiment;

FIG. 13 is a flowchart illustrating a subroutine of S1204;

FIG. 14A is a diagram illustrating a case of not performing warm-up control of a drying heater, as a comparative example;

FIG. 14B is a diagram illustrating an example of warm-up control of the drying heater in a case of performing damage control of the embodiment;

FIG. 15 is a flowchart illustrating an example of pullback control according to the embodiment;

FIG. 16A is a diagram illustrating a case of not performing the pullback control, as a comparative example;

FIG. 16B is a diagram explaining the pullback control of the embodiment;

FIG. 17 is a flowchart illustrating an example of damage control according to an embodiment;

FIG. 18 is a flowchart illustrating a modification of the damage control;

FIG. 19 is a table illustrating ink composition;

FIG. 20 is a table illustrating comparative examples and examples of print control of the embodiment;

FIG. 21 is a table illustrating examples of the print control of the embodiment; and

FIG. 22 is a table illustrating examples of the print control of the embodiment.

### DESCRIPTION OF THE EMBODIMENTS

Embodiments of the present disclosure will be described below with reference to the drawings. Note that the relative arrangement of respective components of an apparatus used in the embodiments, the shape of the apparatus, and the like are merely examples and are not limited thereto. The same components will be denoted by the same reference numerals, and repetitive description will be omitted as appropriate.

### First Embodiment

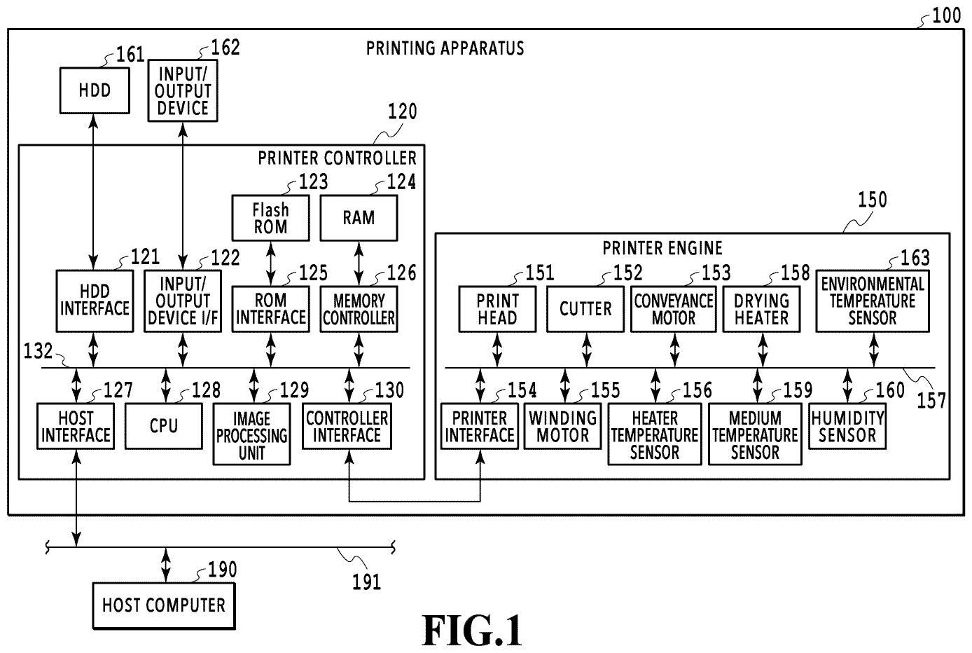

FIG. 1 is a block diagram illustrating a hardware configuration example of a printing apparatus 100 applicable to the present embodiment.

The printing apparatus 100 is an inkjet printer configured to use heat to cure ink. For example, the printing apparatus 100 is used in the sign and display industry. In the present embodiment, a case is assumed where the printing apparatus 100 has a print function only. However, the printing apparatus 100 may further include a reading device for reading images on a document and function as a copier. Furthermore, the printing apparatus 100 may also be a multifunction system having other functions.

As illustrated in FIG. 1, the printing apparatus 100 includes a printer controller 120 configured to control printing, and a printer engine 150 driven for the printing. The printing apparatus 100 also includes a hard disk drive (HDD) 161 for storing predetermined information, and an input/output device 162 configured to input and output various information.

The printer controller 120 includes an HDD interface 121 connected to the HDD 161, and an input/output device interface (input/output device I/F) 122 connected to the input/output device 162. The printer controller 120 also includes a flash ROM 123, a RAM 124, a ROM interface 125 connected to the flash ROM 123, and a memory controller 126 connected to the RAM 124.

The printer controller 120 includes a host interface 127 connected to the outside of the printing apparatus 100, a central processing unit (CPU) 128, and an image processing unit 129 configured to perform various image processing. The printer controller 120 also includes a controller interface 130 connected to the outside of the printer controller 120, and a first system bus 132 for connecting the respective units inside the printer controller 120.

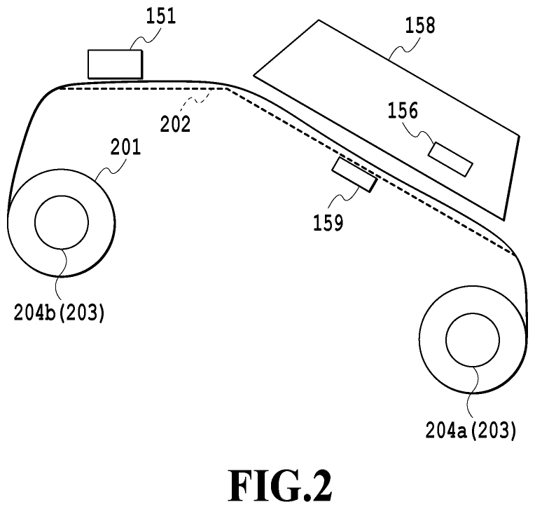

The printer engine 150 includes a liquid ejection head for ejecting a liquid as droplets. In the present embodiment, a print head 151 for ejecting ink as ink droplets is used as the liquid ejection head. The printer engine 150 also includes a cutter 152 for cutting a print medium 201 (see FIG. 2), and a conveyance motor 153 for driving a conveyance roller (not illustrated). The printer engine 150 includes a drying heater 158 for drying the print medium 201, a printer interface 154 connected to the controller interface 130, and a winding motor 155 for driving a winding unit 203 (see FIG. 2).

The printer engine 150 includes a heater temperature sensor 156 for detecting the temperature of the drying heater 158, a medium temperature sensor 159 for detecting the temperature of the print medium 201, and an environmental temperature sensor 163 for detecting the environmental temperature around the printing apparatus 100. The printer engine 150 also includes a humidity sensor 160 for detecting the environmental humidity around the printing apparatus 100, and a remaining amount sensor (not illustrated) for detecting the remaining amount of ink. The printer engine 150 includes a second system bus 157 for connecting the respective units inside the printer engine 150.

The host interface 127 of the printing apparatus 100 is connectable to a host computer 190 via a network 191.

The CPU 128 is in the form of a microprocessor (microcomputer) and controls the overall operation of the printing apparatus 100 by executing programs and activating hardware. The flash ROM 123 stores programs to be executed by the CPU 128 and fixed data required for various operations of the printing apparatus 100. The RAM 124 is used as a work area for the CPU 128. The RAM 124 can also be used as a temporary storage area for various received data and various setting data.

The image processing unit 129 performs various image processing operations. For example, the image processing unit 129 performs processing of expanding (converting) print data handled by the printing apparatus 100 (for example, data expressed in a page description language) into image data (bitmap image data), as well as other image processing operations. The image processing unit 129 converts a color space (for example, YCbCr) of the image data contained in the inputted print data into a standard RGB color space (for example, sRGB).

Furthermore, the image processing unit 129 performs various image processing on the image data as needed, such as resolution conversion to an effective pixel count (that can be subjected to print processing by the printing apparatus 100), image analysis, and image correction. The image data obtained through these image processing operations is stored in the RAM 124 or HDD 161.

The HDD 161 can store and read programs to be executed by the CPU 128, print data, and setting information required for various operations of the printing apparatus 100 in and out of its built-in hard disk. Note that a large-capacity storage device other than the HDD 161 may be provided, instead of the HDD 161.

The print head 151 prints an image on the print medium 201 based on the image data. The print head 151 prints an image on the print medium 201 by ejecting ink from the print head 151 in synchronization with the conveyance of the print medium 201. For example, full-color printing on the print medium 201 can be performed by ejecting yellow, magenta, cyan, and black ink from the print head 151. Note that the ink colors applicable to the technology of the present disclosure are not limited to these four colors.

The cutter 152 includes a mechanism for cutting the print medium 201. The cutter 152 cuts the print medium 201 with an image printed thereon to a predetermined length, for example.

The conveyance motor 153 is a motor for driving conveyance rollers (not illustrated) for conveying the print medium 201. The driving of the conveyance motor 153 is controlled by the CPU 128.

The winding motor 155 is a motor for rotating the winding unit 203 (see FIG. 2) forward and backward. The rotation direction and rotation speed of the winding motor 155 are controlled by the CPU 128.

A plurality of remaining amount sensors (not illustrated) are provided in ink tanks for storing and supplying ink. The remaining amount sensors (not illustrated) detect whether ink is present at each point inside the ink tank.

A plurality of drying heaters 158 are provided in the conveyance path of the print medium 201. The drying heaters 158 facilitate curing of the ink ejected onto the print medium 201. In a case where the ink contains a thermosetting-type component such as resin, the component is cured by heating the ink, thereby fixing the ink to the print medium 201.

The heater temperature sensor 156 and the medium temperature sensor 159 are provided on the conveyance path of the print medium 201. The temperature value of the drying heater 158 detected by the heater temperature sensor 156 is used to control the temperature of the drying heater 158. The temperature value of the print medium 201 detected by the medium temperature sensor 159 is used to control the conveyance of the print medium 201.

The environmental temperature value detected by the environmental temperature sensor 163 is used to control the temperature of the drying heater 158 and the conveyance of the print medium 201. For example, the environmental temperature value is used to determine a wait time from the end of a first print job to the start of a second print job. In a case where the set temperature of the drying heater 158 for the second print job is lower than the set temperature of the drying heater 158 for the first print job, a cooling time needs to be set to lower the temperature of the drying heater 158 to the set temperature for the second print job. The environmental temperature value can be used to determine this cooling time.

The humidity sensor 160 detects the environmental humidity around the location where the printing apparatus 100 is installed. The humidity value detected by the humidity sensor 160 may be used to control the temperature of the drying heater 158 and the conveyance of the print medium 201. For example, in the case of setting the cooling time to lower the temperature of the drying heater 158 to the set temperature for the second print job, using the humidity value allows the cooling time to be derived more accurately, taking into account the amount of moisture contained in the print medium 201.

The input/output device 162 includes hard keys and a touch panel for a user to perform various operations, and a display unit for notifying the user of various information. The input/output device 162 may notify the user of information by generating a sound (for example, a buzzer, voice or the like) based on sound information and outputting the sound from a sound generator.

In the present embodiment, the input/output device 162 is provided as part of the printing apparatus 100. However, the input/output device 162 may also be provided outside the printing apparatus 100. In this case, the input/output device 162 can be connected to the printing apparatus 100 via wireless communication or the like.

For example, the host computer 190 may also serve as the input/output device 162. Another input/output device different from the input/output device 162 may be connected to the printing apparatus 100 via a network or the like. The host computer 190 is, for example, an external apparatus that serves as a supply source of print data. Instead of the host computer 190, other devices that serve as the supply sources of print data, such as an image reader, a digital camera, or a smartphone, may be connected to the printing apparatus 100.

FIG. 2 is a cross-sectional view illustrating an example of a conveyance path applicable to the present embodiment. In FIG. 2, the printing apparatus 100 (see FIG. 1) is illustrated in a posture of normal use.

As illustrated in FIG. 2, the printing apparatus 100 includes the winding unit 203 for winding the print medium 201 in a fixed manner, and a platen 202 for smoothly supporting a portion of the print medium 201 where printing is performed. In the present embodiment, roll sheet is used as the print medium 201.

The print head 151 is also provided above the platen 202. In the conveyance path of the print medium 201, the print head 151 is provided on the upstream side of the drying heater 158 in the conveyance direction.

By driving the drying heater 158, the print medium 201 located near (for example, directly below) the drying heater 158 is heated. The heater temperature sensor 156 is provided near the drying heater 158. The medium temperature sensor 159 is provided below the drying heater 158 and the platen 202. By providing the medium temperature sensor 159 in this manner, the temperature of the print medium 201 heated by the drying heater 158 can be detected.

The leading edge of the print medium 201 is fixed in advance to a first shaft rod 204a of the winding unit 203. On the upstream side of the print head 151, the print medium 201 is wound into a roll and fixed to a second shaft rod 204b of the winding unit 203. During printing, the print medium 201 is conveyed on the platen 202.

In the present embodiment, a space where the temperature is higher than the surrounding environment is provided on the conveyance path of the print medium 201. The ink is cured as the print medium 201 passes through this space. Specifically, the ink is cured by heating the print medium 201 with the drying heater 158 to evaporate the moisture in the ink applied to the print medium 201 or change its components.

The optimal temperature for curing the ink varies depending on the type and material of the print medium 201, or the amount of ink applied per unit area. For this reason, in a case of continuously executing a plurality of print jobs using the same print medium 201, the set temperature of the drying heater 158 is sometimes changed for each print job. On the other hand, with a typical thermal heater, it takes several minutes to reach the set temperature, although this time depends on the initial temperature. Even if a thermal heater with a high maximum output is used, lowering the temperature of the heater requires waiting for heat dissipation.

For example, a case is assumed where a first print job in which the set temperature of the drying heater 158 is 80° C. is followed by a second print job in which the set temperature of the drying heater 158 is 60° C. In this case, in order to execute the second print job, it is necessary to wait for the temperature of the drying heater 158 to drop by 20° C.

However, unless the print medium 201 is removed during this wait time, the region of the print medium 201 located in the heating area of the drying heater 158 continues to be heated at the temperature between 60° C. and 80° C. The set temperature of the drying heater 158 is set to the optimum temperature in a state where the ink is applied onto the print medium 201. Therefore, in a case where a non-printed portion of the print medium 201 where no ink is applied continues to be heated, this non-printed portion becomes overheated and damaged.

In a case where the non-printed portion of the print medium 201 becomes scorched or deformed, for example, the quality of an image printed on the non-printed portion deteriorates. This may further adversely affect cutting and laminating processes that follow the print process, and may reduce the quality of the printed product.

Therefore, in the present embodiment, after the completion of the first print job, the first shaft rod 204a and the second shaft rod 204b continue to rotate forward (clockwise in the example of FIG. 2), thereby continuously conveying the print medium 201 along the conveyance direction (from left to right in the example of FIG. 2). This allows the non-printed portion of the print medium 201, where an image of the second print job is scheduled to be printed, to be retracted to the downstream side of the drying heater 158, and avoids the influence of the drying heater 158 from being concentrated in the same region of the print medium 201.

Then, just before the second print job is started, the first shaft rod 204a and the second shaft rod 204b are rotated backward (counterclockwise in the example of FIG. 2), thereby conveying the print medium 201 in the reverse direction (from right to left in the example of FIG. 2) opposite to the conveyance direction. This can avoid the non-printed portion of the print medium 201 (particularly, the start position of the second print job) from being overheated by the drying heater 158 until the temperature of the drying heater 158 drops to the set temperature for the second print job.

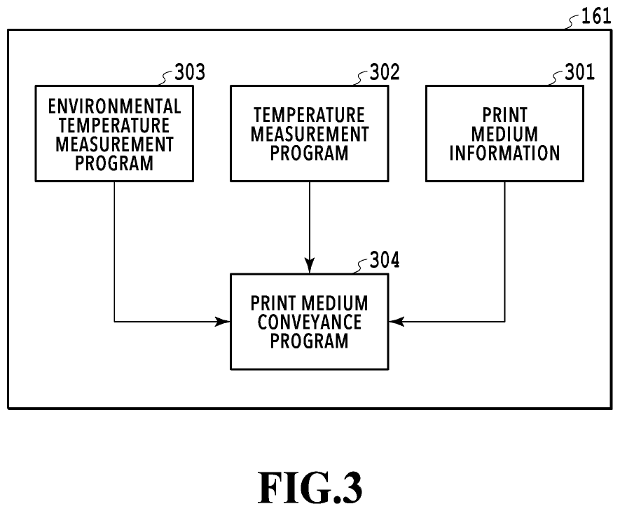

FIG. 3 is a block diagram illustrating a software configuration example of the present embodiment. Each program illustrated in FIG. 3 is part of a program executed by the CPU 128.

As illustrated in FIG. 3, the HDD 161 stores print medium information 301, a temperature measurement program 302, an environmental temperature measurement program 303, and a print medium conveyance program 304. The environmental temperature measurement program 303 is a program for the CPU 128 (see FIG. 1) to detect the room temperature of the environment in which the printing apparatus 100 (see FIG. 1) is installed, using the environmental temperature sensor 163 (see FIG. 1). The temperature measurement program 302 is a program for the CPU 128 to detect the temperature of the print medium 201 (see FIG. 2) using the medium temperature sensor 159 (see FIG. 1).

The print medium information 301 includes conditions for the occurrence of state changes (for example, scorching, deformation or the like) associated with each type of the print medium 201, as well as conditions for cooling after heating. The print medium 201 is cooled by natural heat dissipation after the completion of the first print job and before the start of the second print job. By naturally cooling the print medium 201, sudden changes in temperature of the print medium 201 can be reduced.

The print medium conveyance program 304 is a program for the CPU 128 to determine the conveyance speed and conveyance direction of the print medium 201. The conveyance speed and conveyance direction of the print medium 201 are determined based on information obtained in accordance with the print medium information 301, the temperature measurement program 302, and the environmental temperature measurement program 303.

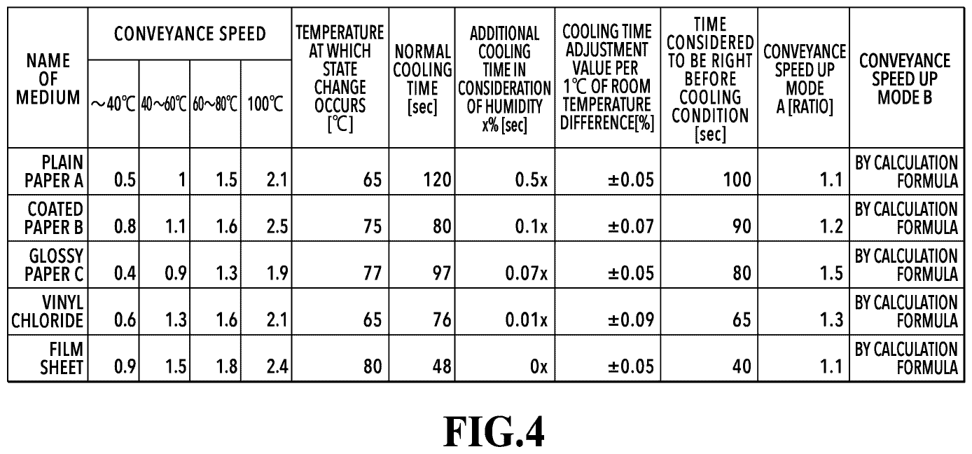

FIG. 4 is a diagram illustrating an example of the print medium information 301 (see FIG. 3) applicable to the present embodiment.

As illustrated in FIG. 4, in the present embodiment, a plurality of types of information required for printing are predetermined for a plurality of types of print media 201.

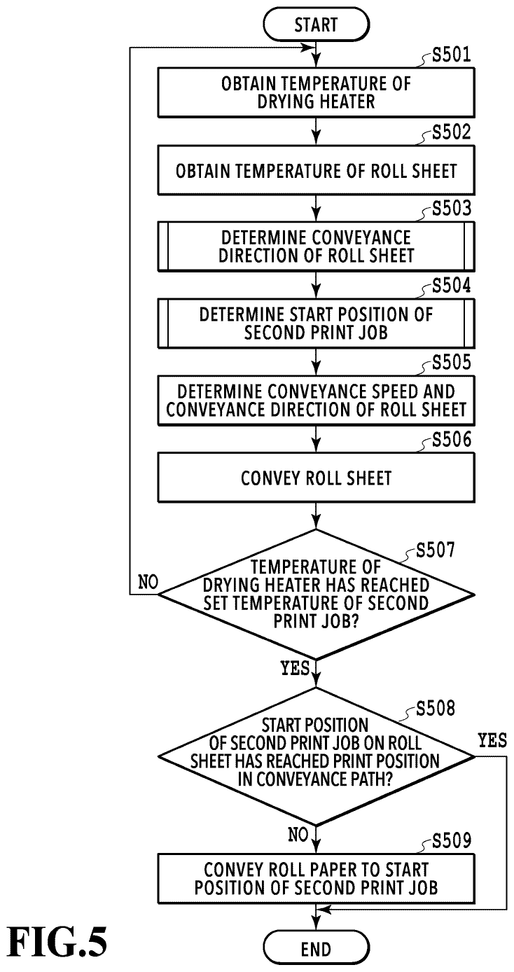

“Conveyance speed [ppm]” is predetermined to increase as the temperature of the print medium 201 increases. Note that “conveyance speed [ppm]” serves as one of the criteria for determination in S405 of FIG. 5 (to be described later).

“Temperature at which state change occurs” indicates that the conveyance control of the print medium 201 is entirely performed at a temperature lower than those of the print media 201 listed in this column.

“Normal cooling time” is one of a plurality of cooling conditions. “Normal Cooling Time” indicates the time it takes for the heating effect of the drying heater 158 (see FIG. 1 and the like) to fall below a certain level in a case where the reference environmental temperature is 25° C.

“Cooling time adjustment value per 1° C. of room temperature difference” is used as an adjustment coefficient for “normal cooling time” in a case where the actual environmental temperature is higher or lower than normal.

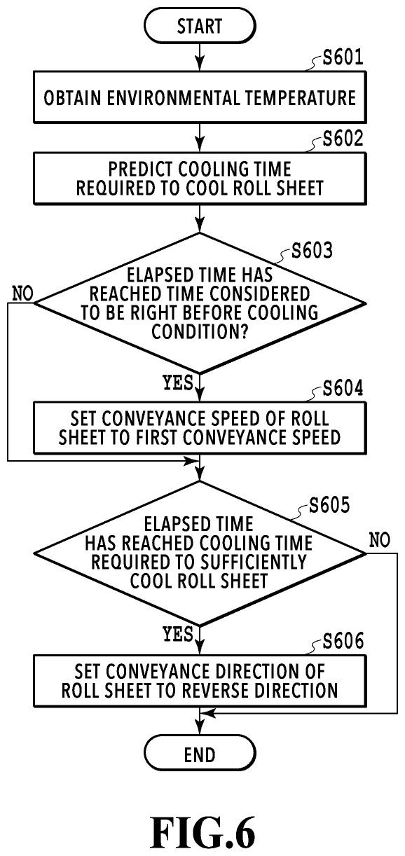

“Time considered to be right before cooling condition” is the reference value used in S603 (see FIG. 6).

“Conveyance speed up mode A” is a ratio used in S604 (see FIG. 6) to increase the conveyance speed. The conveyance speed can be increased by multiplying “conveyance speed [ppm]” by the ratio of “conveyance speed up mode A”.

A value calculated using (Formula 1) to be described later is set as “conveyance speed up mode B”. The cooling time for the print medium 201 may be determined taking into account not only the temperature but also the environmental humidity. Specifically, the normal cooling time may be extended taking into account not only the temperature but also the humidity, and control may be performed to bring the amount of moisture absorbed by the print medium 201 as close as possible to the state before heating by the drying heater 158. The example of FIG. 5 illustrates “additional cooling time in consideration of humidity x%”.

More specifically, in a case of cooling plain sheet A under an environment of 60% humidity, the cooling time for the plain sheet A is extended by 30 seconds (0.5×60(%)=30 (sec)). In other words, the cooling time for the plain sheet A in this case is (150 seconds) obtained by adding 30 seconds to the normal cooling time (120 seconds). This configuration makes it possible to appropriately set the wait time (for example, the cooling time for the roll sheet) between the end of the first print job and the start of the second print job, in consideration of the amount of moisture contained in the print medium 201, by obtaining the humidity around the printing apparatus 100.

FIG. 5 is a flowchart illustrating a flow of conveyance control applicable to the present embodiment.

A series of processing of the flow illustrated in FIG. 5 is performed by the CPU 128 (see FIG. 1) expanding and executing a control program stored in Flash ROM 123 and HDD 161 into the RAM 124. In the following description, the symbol “S” denotes a step. The same applies to other flowcharts illustrated in other drawings.

In the present embodiment, it is assumed that after a first print job (a preceding print job) is completed for one roll of sheet, a second print job (a print job subsequent to the first print job) is performed subsequent to the first print job.

As the flow illustrated in FIG. 5 starts, the last image printed by the first print job has been wound up by the winding unit 203 (see FIG. 2), and a non-printed portion of the roll sheet is present below the drying heater 158 (see FIG. 1).

In this state, the non-printed portion can be used as the start position for the second print job by rewinding the roll sheet. By rewinding the roll sheet after the first print job is completed and printing an image for the second print job on the rewound portion, the roll sheet can be used appropriately without waste.

There is also a case where the temperature setting of the drying heater 158 for the first print job is different from the temperature setting of the drying heater 158 for the second print job. For example, in a case where the amount of ink ejected in the second print job is smaller than the amount of ink ejected in the first print job, the set temperature of the drying heater 158 for the second print job may be lower than the set temperature of the drying heater 158 for the first print job. In this case, it is necessary to wait for the set temperature of the drying heater 158 to drop from the set temperature upon execution of the first print job to the set temperature upon execution of the second print job.

In a case where the non-printed portion of the roll sheet continues to be heated by the drying heater 158 during this wait time, the state of the non-printed portion may change as described above. It is also conceivable not to use the non-printed portion as the start position for the second print job, but this would result in wasted roll sheet.

Therefore, in the present embodiment, after the first print job is completed and before printing of the second print job starts, the roll sheet is preliminarily conveyed (hereinafter referred to as preliminary conveyance) in the conveyance direction and then conveyed backward in the reverse conveyance direction. In this way, the printing apparatus 100 of the present embodiment suppresses overheating of the start position of the second print job by the drying heater 158.

The flow illustrated in FIG. 5 is triggered to start as the temperature setting of the drying heater 158 (see FIG. 1) is changed for the second print job after the completion of the first print job and before the start of the print operation of the second print job. At the start of this processing, the roll sheet is conveyed in the conveyance direction at a predetermined conveyance speed.

In S501, the CPU 128 (see FIG. 1) obtains the temperature of the drying heater 158 detected by the heater temperature sensor 156.

In S502, the CPU 128 obtains the temperature of the roll sheet (printing medium 201 (see FIG. 2)) detected by the medium temperature sensor 159 (see FIG. 1).

In S503, the CPU 128 determines the conveyance direction and conveyance speed of the roll sheet.

FIG. 6 is a flowchart illustrating a subroutine of S503.

In S601, the CPU 128 obtains the environmental temperature around the printing apparatus 100 (see FIG. 1) detected by the environmental temperature sensor 163 (see FIG. 1).

In S602, the CPU 128 obtains information indicating the type of roll sheet and predicts the cooling time required to cool the roll sheet by referring to the print medium information 301 (see FIG. 3).

In S603, the CPU 128 obtains the elapsed time since the start of the flowchart in FIG. 5 and determines whether the elapsed time has reached “time considered to be right before cooling condition (see FIG. 4)”. In a case where the elapsed time has reached “time considered to be right before cooling condition”, the CPU 128 executes processing of S604. On the other hand, in a case where the elapsed time has not reached “time considered to be right before cooling condition”, the CPU 128 executes processing of S605 without executing the processing of S604.

In S604, the CPU 128 sets the conveyance speed for preliminary conveyance of the roll sheet to a first conveyance speed that is faster than a predetermined conveyance speed (for example, the current conveyance speed). For example, the CPU 128 sets the roll sheet conveyance speed to “conveyance speed up mode A (see FIG. 4)”.

In S605, the CPU 128 obtains the elapsed time since the start of the flowchart in FIG. 5 and determines whether the elapsed time has reached the cooling time required to sufficiently cool the roll sheet. For example, the CPU 128 determines whether the roll sheet has been cooled for at least “normal cooling time (see FIG. 4)”. In a case where the elapsed time has reached the cooling time required to sufficiently cool the roll sheet, the CPU 128 executes processing of S606. On the other hand, in a case where the elapsed time has not reached the cooling time required to sufficiently cool the roll sheet, the CPU 128 executes the processing of S503 (see FIG. 5) without executing the processing of S606.

In S606, the CPU 128 sets the roll sheet conveyance direction to the reverse direction. In other words, the CPU 128 sets the winding motor 155 (see FIG. 1) to rotate backward. This causes the first shaft rod 204a and the second shaft rod 204b (see FIG. 2) to rotate backward, thereby conveying the roll sheet in the reverse direction.

The subroutine of S503 has been described above. With reference again to FIG. 5, the conveyance control of the present embodiment will be described below.

In S504, the CPU 128 determines the start position of the second print job.

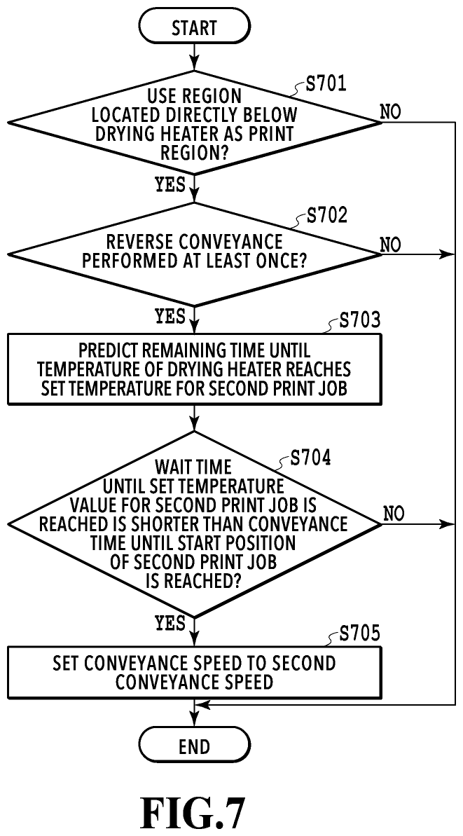

FIG. 7 is a flowchart illustrating a subroutine of S504.

In S701, the CPU 128 determines, based on information previously inputted by the user, whether to use the region of the roll sheet located directly below the drying heater 158 at the end of the first print job as a region for printing an image of the second print job. Specifically, the CPU 128 determines whether to use the non-printed portion of the roll sheet located directly below the drying heater 158 at the end of the first print job as the start position of the second print job.

In this process, the print start position on the roll sheet for the image of the second print job is determined. In a case where the non-printed portion of the roll sheet located directly below the drying heater 158 at the end of the first print job is used as the start position of the second print job, the image of the first print job and the image of the second print job will be printed in consecutive positions in the conveyance direction. In this case, no unnecessary non-printed portion is interposed between the image of the first print job and the image of the second print job.

In a case where the non-printed portion of the roll sheet located directly below the drying heater 158 at the end of the first print job is used as the start position of the second print job, the CPU 128 executes processing of S702. On the other hand, in a case where the preliminarily conveyed non-printed portion is not to be used, the CPU 128 executes the processing of S504 (see FIG. 5) without executing the processing of S702 to S705.

In S702, the CPU 128 determine whether reverse conveyance of the roll sheet is performed at least once, by referring to information indicating the rotation direction history of the winding motor 155 (see FIG. 1) stored in the flash ROM 123 (see FIG. 1). In a case where the reverse conveyance of the roll sheet is performed, the CPU 128 executes processing of S703. On the other hand, in a case where the reverse conveyance of the roll sheet is not performed, the CPU 128 executes the processing of S504 without executing the processing of S703 to S705.

In S703, the CPU 128 uses a known method to predict the remaining time until the temperature of the drying heater 158 reaches the set temperature for the second print job.

In S704, the CPU 128 estimates the time required to convey the print start position for the second print job on the roll sheet, which is determined in S701, to a printable position for the print head 151, at a predetermined conveyance speed. This estimated time is then compared with the remaining time predicted in S703. In a case where the estimated time is shorter than the remaining time, the CPU 128 executes processing of S705. On the other hand, in a case where the estimated time is equal to or longer than the remaining time, the CPU 128 executes the processing of S504 without executing the processing of S705.

In S705, the CPU 128 sets the roll sheet conveyance speed to a second conveyance speed that is faster than the predetermined conveyance speed. This is done so that the execution of the second print job can be started as soon as possible after the set temperature for the second print job is reached. For example, the conveyance speed is set by the CPU 128 to “conveyance speed up mode B (see FIG. 4)”. The conveyance speed in “conveyance speed up mode B” is calculated using Formula 1 below.

“Conveyance speed in conveyance speed up mode B”=“distance from return position for previous reverse conveyance to start position of second print job”÷(“time required for temperature of drying heater 158 to reach set temperature for second print job”−“time required for reverse conveyance”) (Formula 1)

Note that “time required for reverse conveyance” is a value considered in a case where the start position of the second print job on the roll sheet is conveyed to a position upstream of the print position on the conveyance path (for example, directly below the print head 151). In other words, in a case where the roll sheet is conveyed in the normal conveyance direction (from left to right in the example of FIG. 2), “time required for reverse conveyance” is “0”.

The setting for conveyance control in the present embodiment is carried on below with reference to FIG. 5.

In S505, the CPU 128 determines the conveyance speed and conveyance direction of the roll sheet.

In S506, the CPU 128 conveys the roll sheet at the conveyance speed determined in S505 in the conveyance direction determined in S505. That is, in a case where the conveyance speed and conveyance direction of the roll sheet are changed by the processing of S503 and S504, those changes are reflected. In a case where the conveyance speed and conveyance direction of the roll sheet are not changed by the processing of S503 and S504, the current conveyance is continued.

In S507, the CPU 128 determines whether the temperature of the drying heater 158 has reached the set temperature of the drying heater 158 for the second print job. In a case where the temperature of the drying heater 158 has reached the set temperature of the drying heater 158 for the second print job, the CPU 128 executes the processing of S508. On the other hand, in a case where the temperature of the drying heater 158 has not reached the set temperature of the drying heater 158 for the second print job, the CPU 128 repeats the processing of S501 to S506.

In S508, the CPU 128 uses a known method to determine whether the start position of the second print job on the roll sheet has reached the print position in the conveyance path. For example, the CPU 128 determines whether the start position of the second print job set by machine learning is located directly below the print head 151. In a case where the start position of the second print job has reached the print position, the CPU 128 ends the flowchart of FIG. 5 without executing processing of S509. On the other hand, in a case where the start position of the second print job has not reached the print position, the CPU 128 executes the processing of S509.

In S509, the CPU 128 conveys the roll sheet until the start position of the second print job on the roll sheet reaches the print position in the conveyance path.

The conveyance control in the present embodiment has been described above.

As described above, in the present embodiment, upon completion of the first print job, the portion of the roll sheet with the image of the first print job printed therein is wound up by the winding unit 203 (see FIG. 2). Therefore, at the end of the first print job, the image printed by the first print job is not present directly below the drying heater 158, and the non-printed portion of the roll sheet is located directly below the drying heater 158. By then performing the preliminary conveyance from this state, the roll sheet is further wound up in the conveyance direction. This makes it possible to avoid heating of the non-printed portion of the roll sheet for an extended period of time by the drying heater 158.

However, unless the roll sheet is rewound, the preliminarily conveyed non-printed portion cannot be used as the start position of the second print job.

Therefore, while the roll sheet is preliminarily conveyed in the conveyance direction (during preliminary conveyance), the roll sheet is rewound as a predetermined time (for example, the time considered to be right before the cooling condition (see FIG. 4)) elapses. Then, the start position of the second print job is located directly below the print head 151 (see FIG. 1), and the second print job is started.

With this configuration, after the first print job is completed, the roll sheet is preliminarily conveyed, and then conveyed in the reverse direction just before the start of the second print job. In other words, the roll sheet is continuously conveyed after the completion of the first print job and before the start of the second print job. By not stopping the conveyance of the roll sheet after the completion of the first print job and before the start of the second print job, a specific portion of the roll sheet can be avoided from being intensively heated by the drying heater 158.

This reduces the possibility that the start position of the second print job on the roll sheet gets overheated and distorted, making it unsuitable as a region for printing.

As a result, the printing apparatus of the present embodiment allows for appropriate use of the roll sheet without waste.

Furthermore, in the present embodiment, the conveyance and reverse conveyance performed after the completion of the first print job and before the start of the second print job, the conveyance speed is faster than the predetermined conveyance speed. This makes it possible to disperse the heat received from the drying heater 158 by the non-printed portion of the roll sheet, compared to the case where the roll sheet is conveyed forward and backward at the predetermined conveyance speed (for example, the conveyance speed during print processing).

In other words, by conveying the roll sheet forward and backward after the completion of the first print job and before the start of the second print job, the region downstream of the start position of the second print job is also heated by the drying heater 158. However, by setting the conveyance speed faster than the predetermined conveyance speed, the possibility of the region downstream of the start position of the second print job being overheated by the drying heater 158 can be reduced.

It is also conceivable to remove the roll sheet from the printing apparatus to be cooled between the end of the first print job and the start of the second print job. However, the technology of the present disclosure eliminates the need to come close to the printing apparatus in a relatively high-temperature state to remove the roll sheet. Therefore, the technology of the present disclosure can also ensure safety in print operations.

### Second Embodiment

A configuration different from the configuration of the printing apparatus 100 of the first embodiment will be mainly described below. The same or corresponding components as those of the printing apparatus 100 of the first embodiment will be denoted by the same reference numerals, and description thereof will be omitted.

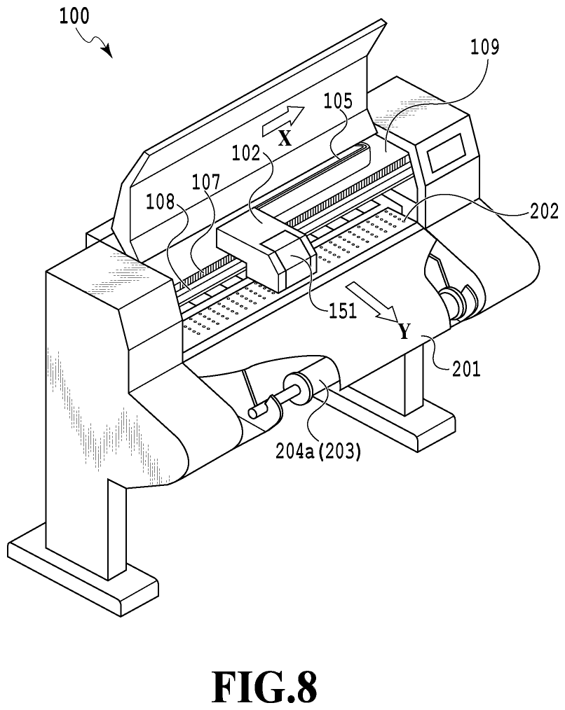

FIG. 8 is an external perspective view of a printing apparatus 100 of the present embodiment.

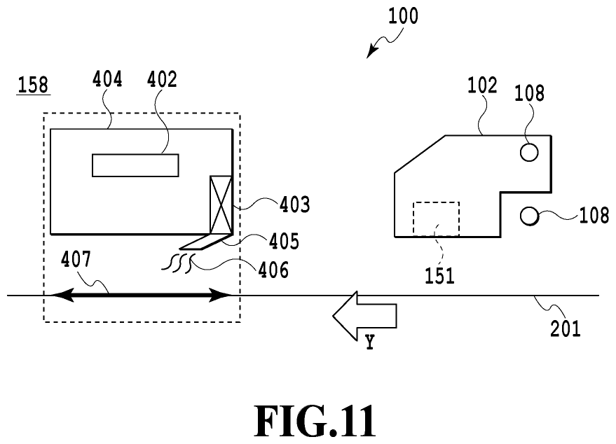

FIG. 8 specifically illustrates the outer appearance of the printing apparatus 100 of the second embodiment. The printing apparatus 100 of the present embodiment includes a drying heater 158 (see FIG. 2, FIG. 11 or the like) which functions as a heating device to be described later, and a conveyance control mechanism (for example, a winding unit 203) for controlling the conveyance of a print medium 201.

The heating device of the present embodiment is capable of controlling heating conditions under various conditions. By controlling conveyance according to the type of the print medium 201 or the heating conditions, the printing apparatus 100 of the present embodiment minimizes damage to the print medium 201 due to heating by the heating device while efficiently using the print medium 201.

### Schematic Configuration

The printing apparatus 100 of the present embodiment is a so-called serial scan type inkjet printer. The printing apparatus 100 of the present embodiment prints an image by scanning a print head 151 in an X direction (scanning direction) orthogonal to a Y direction (conveyance direction) of the print medium 201. With reference to FIG. 8, a configuration of the printing apparatus 100 of the present embodiment and an overview of its operation upon printing will be described below.

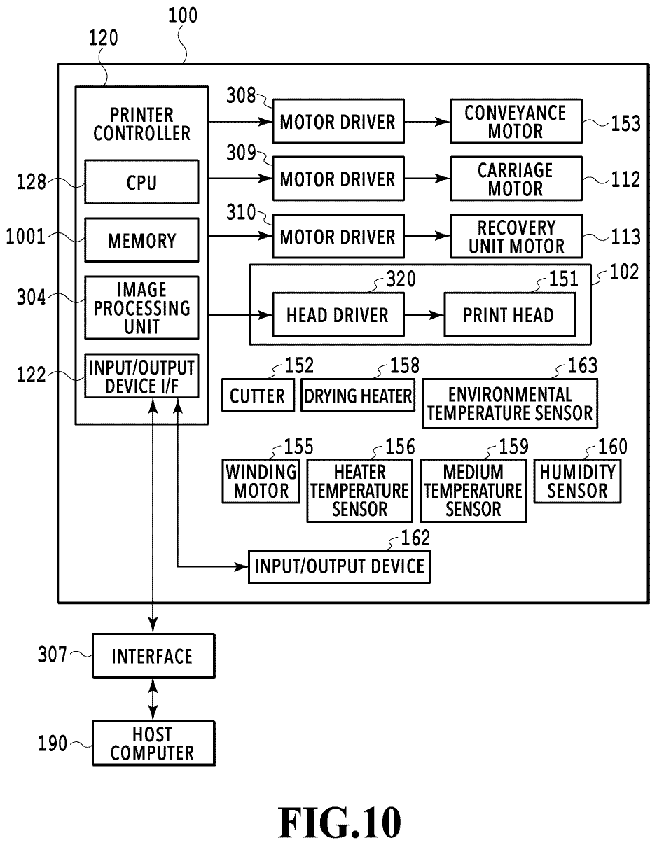

First, the print medium 201 is conveyed in the Y direction by a conveyance roller (not illustrated) driven via gears by a conveyance motor 153 (see FIG. 10) and a first shaft rod 204a driven by a winding motor 155 (see FIG. 10).

In the printing apparatus 100 of the present embodiment, a spool is used as the first shaft rod 204a. At a predetermined conveyance position, a carriage unit 102 driven by a carriage motor 112 (see FIG. 10) reciprocally scans (reciprocally moves) along a guide shaft 108 extending in the X direction.

The print head 151 to be described later is mounted on the carriage unit 102. During this scanning process, ink is ejected from nozzles of the print head 151 at a timing based on a position signal obtained by an encoder 107, thereby printing an image having a certain bandwidth corresponding to the nozzle array range. The conveyance motor 153 is then driven to convey the print medium 201 by a distance corresponding to the bandwidth, and printing is further performed for the next bandwidth.

The fed print medium 201 is pinched and conveyed between a sheet feed roller and a pinch roller (not illustrated) and guided to a print position (scanning area of the print head 151) on a platen 202. Normally, in an idle state, an ejection port surface of the print head 151 provided with ejection ports from which ink is ejected is capped by a cap (not illustrated) provided in a recovery unit (not illustrated). Therefore, prior to printing, the cap is opened to prepare the print head 151 and the carriage unit 102 for scanning. Thereafter, once data for one band is accumulated in a buffer, the carriage motor 112 causes the carriage unit 102 to scan, and the print head 151 performs printing for the one band as described above.

Note that a carriage belt (not illustrated) can be used to transmit driving force from the carriage motor 112 to the carriage unit 102. However, a method of transmitting the driving force from the carriage motor 112 to the carriage unit 102 is not limited to using the carriage belt. For example, a configuration may be adopted, including a lead screw that is rotationally driven by the carriage motor 112 and extends in the X direction, and an engagement portion that is provided on the carriage unit 102 and engages with a groove in the lead screw. Accordingly, other drive methods can be used, instead of the carriage belt.

The carriage unit 102 of the present embodiment has a scanning speed of 30 inches per second. The print head 151 of the present embodiment performs an ejection operation at a resolution of 1200 dpi ( 1/1200 inch). The print medium 201 is then conveyed for more printing for the next bandwidth.

The print head 151 of the present embodiment is capable of so-called multipass printing for printing an image in a unit area (1/n band) on the print medium 201 through a plurality of (n) scans.

In a printing method of the present embodiment, resin particles contained in the ink are heated by the drying heater 158. For this reason, the heating temperature in the present embodiment is preferably equal to or higher than the minimum film-forming temperature of the resin particles. Furthermore, most of the liquid components in the ink (for example, water-soluble organic solvents) need to be evaporated during heating. Therefore, a temperature distribution is provided in the conveyance direction of the print medium 201 to ensure energy required to evaporate most of the liquid components.

### Print Head 151

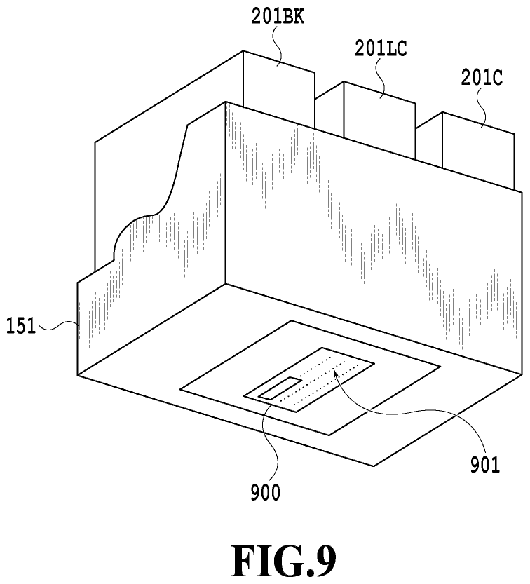

FIG. 9 is a perspective view of the print head 151.

As illustrated in FIG. 9, the print head 151 in the present embodiment is provided with independent buffer tanks 201BK, 201LC, and 201C for three colors of ink, black, light cyan, and cyan, respectively. For the sake of explanation, these buffer tanks are illustrated visible in FIG. 9. However, these buffer tanks are actually housed inside the print head 151.

On a lower surface of the print head 151, a chip 900 is provided, in which nozzle arrays corresponding to each ink are formed. The chip 900 has three nozzle arrays 901, each having 1024 nozzles at an interval of 1200 dpi for one color. Three colors of ink are ejected from one chip 900. Providing three nozzle arrays enables three-color printing.

Note that nozzle arrays for one color do not need to be arranged in the same straight line. For example, three nozzle arrays, each having 512 nozzles at an interval of 600 dpi, may be provided alternately. Furthermore, the number of ink colors ejected from one chip 900 is not limited to three. Here, the print head 151 capable of ejecting three colors of ink, black, light cyan, and cyan, has been described as an example. However, a plurality of such print heads 151 are provided so as to correspond to the types of ink colors to be ejected.

### Overview of Print Operation Control

Next, description will be given of a configuration of a print control system for a print operation using the printing apparatus, print head 151 (see FIG. 8), and inks described above.

FIG. 10 is a block diagram illustrating a configuration example of the print control system of the present embodiment.

As illustrated in FIG. 10, the printing apparatus 100 is connected to a data supply apparatus (for example, a host computer 190 or the like) via an interface 307. Various data and printing-related control signals sent from the host computer 190 are inputted to a printer controller 120.

The printer controller 120 includes: a memory 1001 for storing input image data, multilevel gradation data of intermediate products, and a multipass mask; and a CPU 128 (which may be an ASIC) as an arithmetic unit. The printer controller 120 controls motor drivers 308, 309, and 310 and a head driver 320 included in the carriage unit 102, according to control signals inputted via the interface 307. The printer controller 120 performs image processing on the inputted image data.

The conveyance motor 153 rotationally drives a conveyance roller for conveying the print medium 201. The carriage motor 112 reciprocally drives the carriage unit 102 having the print head 151 mounted thereon. A recovery unit motor 113 is mounted on a recovery unit (not illustrated) to execute recovery processing for the print head 151. The recovery unit motor 113 switches the units to be driven by a camshaft. For example, the recovery unit motor 113 operates a cap and a suction pump.

The motor drivers 308, 309, and 310 drive the conveyance motor 153, the carriage motor 112, and the recovery unit motor 113, respectively. The head driver 320 drives the print head 151. The number of head drivers 320 corresponds to the number of print heads 151. In a case where a plurality of print heads 151 are provided, a corresponding number of head drivers 320 are provided.

The printing apparatus 100 of the present embodiment includes a cutter 152, a winding motor 155, a heater temperature sensor 156, a drying heater 158, a medium temperature sensor 159, a humidity sensor 160, and an environmental temperature sensor 163.

The printer controller 120 of the present embodiment includes an input/output device I/F 122. The input/output device I/F 122 is connected to an input/output device 162. The input/output device 162 includes a panel (not illustrated). As will be described in detail later, the panel of the input/output device 162 displays a screen for designating whether to execute damage control to reduce damage to the print medium 201 (see FIG. 8 and the like) due to heating by the drying heater 158, or for designating the type of the damage control.

### Heating Configuration

A printing method of the present embodiment includes a fixing step of fixing an image to the print medium 201 by heating ink applied to the print medium 201.

In the fixing step, resin contained in the ink is melted to form a film, and most of the liquid components contained in the ink, such as a water-soluble organic solvent and water, are evaporated. Examples of heating methods for evaporating these components include a method of bringing a heat source into direct contact with the print medium, a method of irradiating infrared rays with an infrared heater or microwaves in a non-contact manner, a method of blowing room-temperature or heated gas, and the like. The fixing temperature is preferably equal to or higher than the minimum film-forming temperature of resin particles to form a film.

Furthermore, it is preferable to control the conveyance speed and temperature distribution of the print medium so that the energy required to evaporate most of the liquid components applied to the print medium is obtained during the conveyance process. An example of a drying configuration suitable for performing the fixing step of the present embodiment will be described below.

FIG. 11 is a schematic cross-sectional view of the drying configuration in the printing apparatus 100 of the present embodiment cut along the conveyance direction.

As illustrated in FIG. 11, a fixing unit for fixing the ink to the print medium 201 is provided on the downstream side of the print head 151 in the conveyance direction (Y direction). In the printing apparatus 100 of the present embodiment, the drying heater 158 is used as this fixing unit. The drying heater 158 of the present embodiment blows hot air 406 to fix the ink to the print medium 201.

After ink is applied to the print medium 201 by the print head 151, the print medium 201 is conveyed in the conveyance direction (Y direction) by conveyance rollers (not illustrated).

The arrow 407 in FIG. 11 indicates a heating length in the conveyance direction of the drying heater 158. The direction indicated by the arrow Y in FIG. 11 is referred to as the conveyance direction, and the direction opposite to the conveyance direction indicated by the arrow Y is referred to as the reverse conveyance direction. The conveyance in the conveyance direction that does not involve printing by the print head is referred to as preliminary conveyance, whereas the conveyance in the reverse conveyance direction that does not involve printing by the print head is referred to as reverse conveyance.

In the conveyance control of the present embodiment, for example, after the preliminary conveyance of the print medium 201 in the conveyance direction, the reverse conveyance of the print medium 201 can be performed to return a non-printed portion of the print medium 201 (a portion where no printing is performed) to a print position (for example, directly below the print head 151).

The drying heater 158 of the present embodiment is a mechanism located above the print medium 201 and configured to blow heated gas (for example, hot air 406). The drying heater 158 includes a heating element 402 for heating the gas and an air blower for blowing the hot air 406 onto the print medium 201. Any type of heating element 402 can be used as long as its temperature can be controlled. It is preferable that the heating element 402 has high heat conveyance efficiency with respect to air.

The air blower includes a blast fan 403, an air duct 404, and an air exhaust portion 405. To secure fixing time to supply the energy required to evaporate most of the liquid components, it is preferable that the area indicated by the arrow 407 has a temperature distribution in the conveyance direction. The drying heater 158 includes the heater temperature sensor 156 (see FIG. 10 and the like) inside the air duct 404. The CPU 128 can control the temperature of the heating element 402 based on the temperature detected by the heater temperature sensor 156.

A large amount of vapor may be generated during the fixing step. The fixing efficiency may decrease in a case where the drying heater 158 is filled with vapor. Therefore, a mechanism for collecting and discharging the vapor to the outside may be provided.

### Damage Control for Print Medium 201

The CPU 128 of the present embodiment (see FIG. 10) starts temperature adjustment of the drying heater 158 included in the heating configuration after receiving a print job. The point where the temperature adjustment of the drying heater 158 starts after the print job is received is referred to as a warm-up start point of the drying heater 158, as appropriate.

For example, in a case where a long period of time has passed since the end of a preceding print job, or in a case where the set temperature for the preceding print job is lower than the set temperature for a subsequent print job, the drying heater 158 is controlled to be heated before a print operation of the subsequent print job.

On the other hand, in a case where the set temperature for the preceding print job is higher than the set temperature for the subsequent print job, and the temperature currently detected by the heater temperature sensor 156 is higher than the set temperature for the subsequent print job, the drying heater 158 is controlled to be cooled before the print operation of the subsequent print job. Hereinafter, the process of adjusting the temperature of the drying heater 158 for the subsequent print job, whether it is heating control or cooling control, will be referred to as warm-up in the present embodiment. At the start of warm-up, the print medium 201 is in a position to be heated by the drying heater 158.

Upon receipt of a print job, the leading blank portion of the print medium 201 is typically wound up by the winding unit 203 (see FIG. 8). Therefore, at the start of warm-up, the non-printed portion of the print medium 201 (the portion downstream of the portion where ink is ejected by the print head 151 in the winding direction) is heated. This portion to be heated may deform depending on the heat resistance of the print medium 201 and the amount of heat received from the drying heater, affecting the conveyance.

Furthermore, during a print job, after ink ejection from the print head 151 is completed, the print medium 201 is conveyed to pass through the drying heater 158 to dry and fix the image printed thereon.

In this event, the printing apparatus 100 is designed to complete image fixing by continuing the drying until the ejection end portion (the most upstream portion of the image) passes the most downstream portion of the drying heater 158. This image fixing operation will be hereinafter referred to as the fixing operation of the drying heater 158, as appropriate.

In this event, the non-printed portion on the upstream side of the ejection end portion of the image may be damaged by heat from the drying heater 158, until the trailing edge of the image (ejection end portion) reaches the most downstream portion of the drying heater 158. An image can be printed on the non-printed portion by reversely conveying the print medium 201.

Typically, to use the print medium 201 without waste, the print medium 201 is reversely conveyed once the fixing operation for the preceding print job is completed, so that the leading edge of the next image to be printed follows the trailing edge of the previously printed image. Therefore, the non-printed portion damaged by heating during this fixing operation and reverse conveyance may get jammed, even if the deformation amount is small, as the print head 151 scans.

This non-printed portion may be reheated by the warm-up of the drying heater 158. In this case, the non-printed portion gets damaged once again by the warm-up of the drying heater 158 before the next print operation. Therefore, the non-printed portion may deform during conveyance, affecting the conveyance.

One effective solution to this problem is to implement control to reduce damage to the print medium 201 caused by the drying heater 158. However, reducing the output of the drying heater 158 is not appropriate for drying and fixing the image. In other words, the drying heater 158 needs to be controlled to maintain the same temperature and airflow as during printing. Therefore, the printing apparatus 100 of the present embodiment implements damage control to reduce heat damage.

At the end of the preceding print job, the drying heater 158 is still heated to approximately the same temperature as during printing. Therefore, in a case where reverse conveyance for the next print job is performed while the temperature of the drying heater 158 is high, the non-printed portion of the print medium 201 gets damaged more than the printed portion. Hereinafter, control for suppressing damage to the non-printed portion of the print medium 201 will be described.

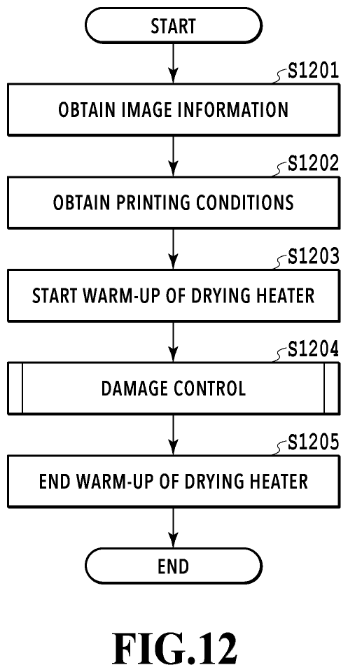

FIG. 12 is a flowchart illustrating an example of warm-up, including damage control for the print medium 201 in the present embodiment.

The flowchart of FIG. 12 is different from the example of FIG. 5, and is triggered to start as the printing apparatus 100 receives a print job. Note that this flowchart is executed assuming that the leading edge of an image of the print job is located in a print position of the print head 151 (directly below the print head). This flowchart will be described below.

In S1201, the CPU 128 (see FIG. 10) obtains image information on the received print job. The image information includes the type of print medium, print quality, and the like besides image data. After completing the processing of S1201, the CPU 128 performs processing of S1202.

In S1202, the CPU 128 obtains printing conditions corresponding to the image information obtained in S1201, by referring to the memory 1001. The printing conditions include the time required to raise the temperature of the drying heater 158 to a temperature suitable for the print job.

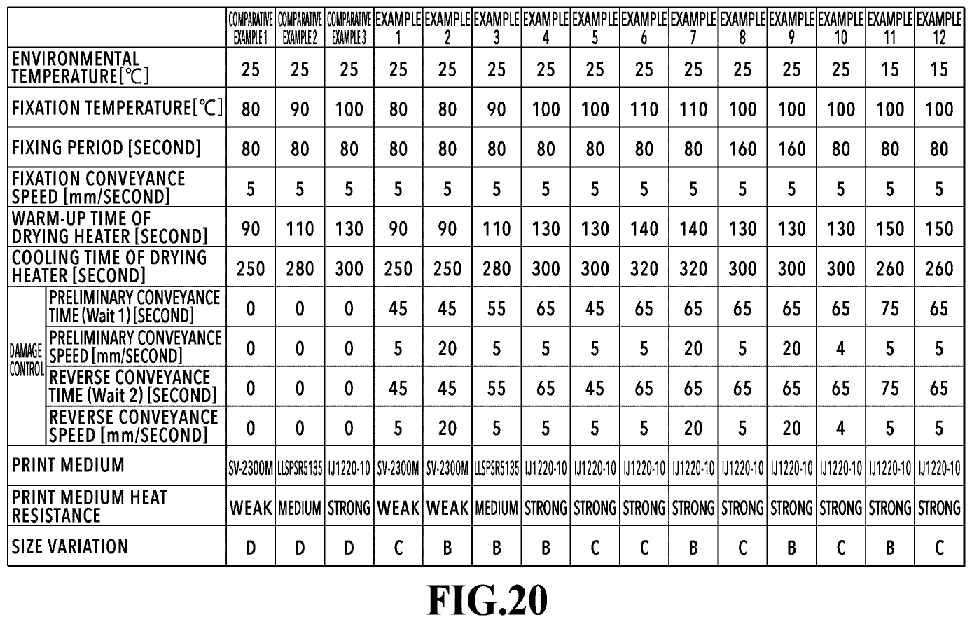

Examples 1 to 12 in FIG. 20 show examples of printing conditions stored (registered) in the memory 1001 in the present embodiment. The CPU 128 selects one of Examples 1 to 12, based on the type of print medium indicated by the image information, the environmental temperature detected by the environmental temperature sensor 163 or the like, and sets the selected one as the printing condition. The printing conditions include the fixing temperature of the drying heater 158, the time required to reach that temperature (warm-up time), the respective times and conveyance speeds of the preliminary conveyance and reverse conveyance performed until warm-up is complete, and the like. After completing the processing of S1202, the CPU 128 performs processing of S1203.

In S1203, the CPU 128 starts warm-up of the drying heater 158, based on the printing conditions obtained in S1202. After completing the processing of S1203, the CPU 128 performs processing of S1204.

In S1204, the CPU 128 performs damage control on the print medium 201.

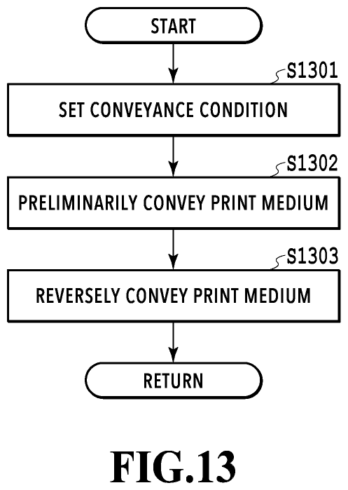

FIG. 13 is a flowchart illustrating a subroutine of S1204.

In S1301, the CPU 128 sets conveyance conditions based on the printing conditions obtained in S1202. The conveyance conditions include the time required for preliminary conveyance (preliminary conveyance time) and the speed of preliminary conveyance (preliminary conveyance speed), as well as the time required for reverse conveyance (reverse conveyance time) and the speed of reverse conveyance (reverse conveyance speed).

As will be described in detail later, the preliminary conveyance speed is preferably set to the same speed as the reverse conveyance speed. The preliminary conveyance time is preferably set to half the time required for the drying heater 158 to reach the temperature suitable for the print job. In other words, the preliminary conveyance time is preferably set to half the time required to for warm-up of the drying heater 158. Furthermore, the reverse conveyance time is preferably set to the same time as the conveyance time. This is because, with this configuration, the printed portion of the print medium 201 can be returned to its original position (the position at the start of the preliminary conveyance) after the preliminary conveyance.

After completing the processing of S1301, the CPU 128 performs processing of S1302.

In S1302, the CPU 128 preliminarily conveys the print medium 201 in the conveyance direction, based on the preliminary conveyance time and preliminary conveyance speed set in S1301. After completing the processing of S1302, the CPU 128 performs processing of S1303.

In S1303, the CPU 128 reversely conveys the print medium 201 in the reverse conveyance direction, based on the reverse conveyance time and reverse conveyance speed set in S1301. After completing the processing of S1303, the CPU 128 returns to the flowchart of FIG. 12.

In S1205, the CPU 128 ends the warm-up of the drying heater 158. More specifically, the CPU 128 ends the warm-up after confirming that the temperature detected by the heater temperature sensor 156 has reached the fixing temperature of the drying heater 158. After completing the processing of S1205, the CPU 128 ends this flowchart.

After completion of this flowchart, a print operation for the print job is started.

The flowcharts of the present embodiment have been described above. The effect of damage control (warm-up control of the drying heater 158) on the print medium 201 in the present embodiment will be described below.

### Warm-Up Control of Drying Heater 158

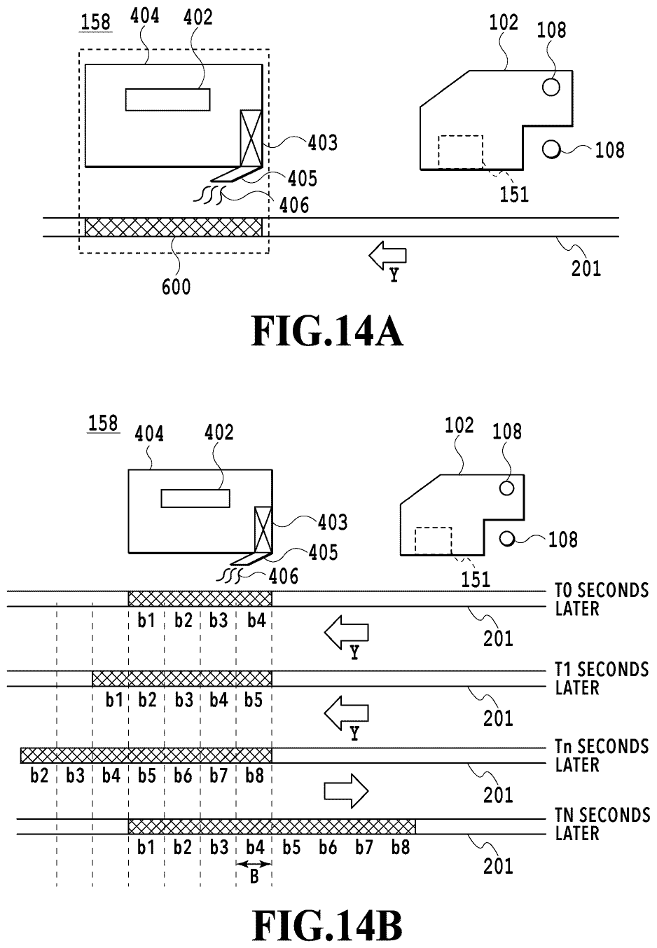

FIG. 14A is a diagram illustrating a comparative example where warm-up control of the drying heater 158 is not performed.

In FIG. 14A, a heated portion 600 indicates a portion of the print medium 201 heated by the drying heater 158. Before the start of a print operation for a new print job, the drying heater 158 adjusts its temperature to dry the print medium 201 at a temperature suitable for that print job. In other words, warm-up of the drying heater 158 for the print job is performed. During this warm-up, hot air 406 is emitted from the drying heater 158.

The heated portion 600 located directly below the drying heater 158 at the start of warm-up is subject to damage from heating by the drying heater 158 during the warm-up period. In a case where an image from the previous print job is printed on the heated portion 600, the image may get scorched or deformed, resulting in deterioration in image quality. Furthermore, even if the heated portion 600 is a non-printed portion, scorching or deformation of the heated portion 600 makes it difficult to print the image of the next print job.

The higher the temperature of the hot air 406 and the greater the volume of the hot air 406, the greater the damage sustained by the heated portion 600. Furthermore, the longer the heated portion 600 remains directly below the drying heater 158, the greater the damage sustained by the heated portion 600.

A configuration for reducing the damage sustained by the heated portion 600 will be described below with reference to FIG. 14B.

FIG. 14B is a diagram illustrating an example of warm-up control of the drying heater 158 in a case where damage control of the present embodiment is performed. In FIG. 14B, the heated portion 600 of the print medium 201 is divided into regions b1, b2, b3, and b4, starting from downstream in the conveyance direction. Here, the regions b1, b2, b3, and b4 are the portions where the image of the preceding print job is printed.

In FIG. 14B, “T0 seconds later” indicates the warm-up start point of the drying heater 158 for a new print job. “T1 seconds later” indicates a time point after the elapse of one second from “T0 seconds later”. “Tn seconds later” indicates a time point after the elapse of n seconds (four seconds in the example of FIG. 14B) from “T0 seconds later”. “TN seconds later” indicates a time point after the elapse of N seconds (eight seconds in the example of FIG. 14B) from “T0 seconds later”. “B” in FIG. 14B indicates a preliminary conveyance amount and a reverse conveyance amount per unit time (for example, one second).

As illustrated in FIG. 14B, at the time point of “T0 seconds later”, the regions b1, b2, b3, and b4 are located directly below the drying heater 158 and heated by the hot air 406.

At the time point “T1 seconds later” after the elapse of one second from “T0 seconds later”, the print medium 201 has been preliminarily conveyed by the conveyance amount B. This preliminary conveyance causes the region b1 to be preliminarily conveyed downstream of the heated portion 600 and to fall outside the heated portion 600. Meanwhile, the region b5 that follows the region b4 is preliminarily conveyed to directly below the drying heater 158 and falls within the heated portion 600.

Thereafter, at the time point “Tn seconds later” after the preliminary conveyance performed for a predetermined period of time, the regions b1 to b4 have been preliminarily conveyed to positions outside the heated portion 600 downstream of the drying heater 158, and the regions b5 to b8 fall within the heated portion 600 directly below the drying heater 158. Note that “Tn seconds later” in FIG. 14B refers to the time point after the preliminary conveyance performed for four seconds.

Subsequently, reverse conveyance is performed for a predetermined period of time (four seconds in the example of FIG. 14B) to return the regions b1 to b4 to their original positions (directly below the drying heater 158) in the heated portion 600.

As a result, damage due to heating by the drying heater 158 is not concentrated in the regions b1 to b4, but dispersed over the regions b1 to b8. This reduces damage to the print medium 201 due to heating by the drying heater 158. In other words, scorching, deformation or the like of the print medium 201 can be reduced.

In a case where preliminary conveyance or reverse conveyance is not performed, a wind speed value of the hot air 406, particularly in the region b3, is the highest in the heated portion 600 (among the regions b1 to b4), and the angle at which the hot air 406 hits tends to be close to perpendicular to the print surface of the print medium 201. Therefore, the largest quantity of heat is received by the region b3, among the regions b1 to b4. Thus, the configuration of the present embodiment involving the preliminary conveyance and the reverse conveyance makes it possible to retract the region b3 subject to great damage.

Even in a case where only the preliminary conveyance is performed during warm-up of the drying heater 158, scorching, deformation or the like of the print medium 201 can be reduced. However, this alone results in many non-printed portions of the print medium 201, making it difficult to efficiently use the print medium 201. Therefore, in the printing apparatus 100 of the present embodiment, the reverse conveyance is performed after the preliminary conveyance. This allows for efficient use of the print medium 201 by reducing the area of the non-printed portion, compared to the case where only the preliminary conveyance is performed and no reverse conveyance is performed.

Furthermore, it is preferable that the preliminary conveyance and the reverse conveyance have the same conveyance amount and conveyance speed. For example, the preliminary conveyance is performed at a predetermined speed for half the time required for warm-up of the drying heater 158, and then the reverse conveyance is performed at the same speed and for the same amount of time as the preliminary conveyance, thus making it possible to set the same conveyance amount for both the preliminary conveyance and the reverse conveyance. With this configuration, the heated portion 600 can be returned to its original position after the preliminary conveyance is completed, allowing the print operation to start immediately after completion of the warm-up of the drying heater 158.

It is also preferable that the preliminary conveyance and the reverse conveyance have a large conveyance amount. By increasing the conveyance amount, the print medium 201 can be quickly retracted from the position heated by the drying heater 158 to the position not heated by the drying heater 158. As a result, the amount of heat received by the drying heater 158 and the damage caused by that heat can be dispersed over a wider range in the print medium 201.

Therefore, the printing apparatus 100 of the present embodiment allows for efficient use of the print medium 201 while suppressing deterioration in quality of the print medium 201 and the image.

### Third Embodiment

A configuration different from the configuration of the printing apparatus 100 of the above-described embodiments will be mainly described below. The same or corresponding components as those of the printing apparatus 100 of the above-described embodiments will be denoted by the same reference numerals, and description thereof will be omitted.

The second embodiment is aimed at reducing damage to the print medium during warm-up for a new job upon receipt of the job. On the other hand, the present embodiment is aimed at reducing damage to the print medium during a cooling period of the drying heater 158 having its temperature adjusted for one job, upon completion of the job. Hereinafter, damage control for the print medium 201 in the present embodiment will be referred to as “pullback control” as appropriate.

### Pullback Control

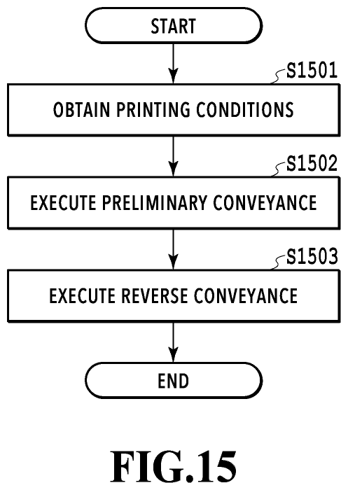

FIG. 15 is a flowchart of pullback control in the present embodiment. This flowchart is triggered to start by the completion of a print operation of any print job.

In S1501, the CPU 128 obtains printing conditions corresponding to the completed print job by referring to the memory 1001.

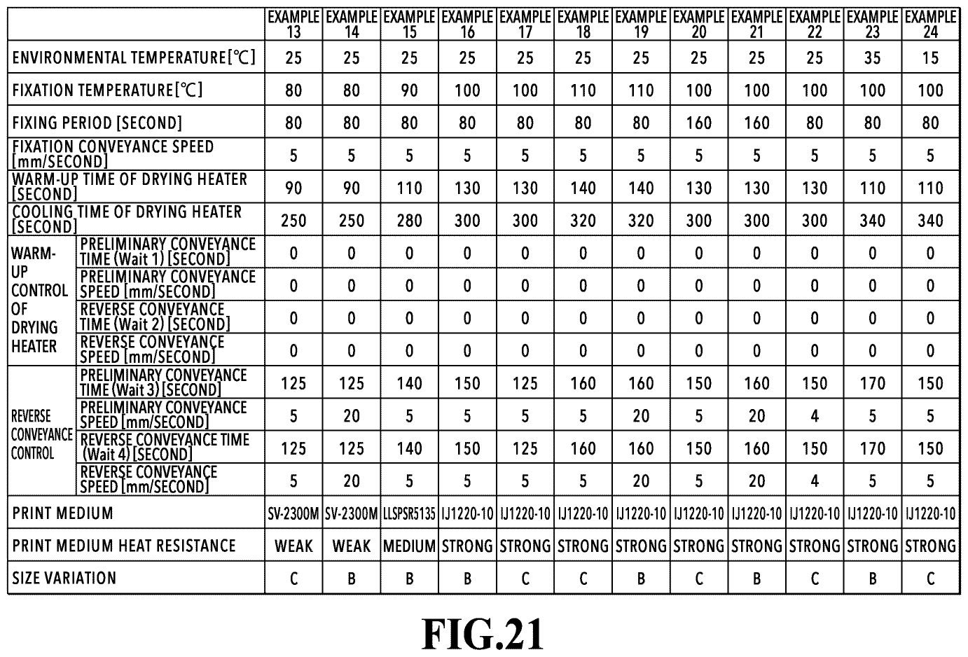

Examples 13 to 24 in FIG. 21 show examples of printing conditions stored (registered) in the memory 1001 in the present embodiment. The CPU 128 selects and sets an example corresponding to the completed print job. These printing conditions include the cooling time of the drying heater 158, respective times and conveyance speeds of preliminary conveyance and reverse conveyance performed before the cooling is complete, and the like. Note that these printing conditions may be obtained in advance at the start of processing for the print job, rather than in S1501.

In S1502, the CPU 128 executes preliminary conveyance based on the printing conditions obtained in S1501.

In S1503, the CPU 128 executes reverse conveyance based on the printing conditions obtained in S1501.

After completing the processing of S1503, the CPU 128 ends this flowchart.

This flowchart has been described above. In a case where a new print job has already been submitted after the completion of this flowchart, processing for the new print job starts immediately. In a case where a new print job has not yet been submitted, the processing waits with the start position of the new print job set directly below the print head 151.

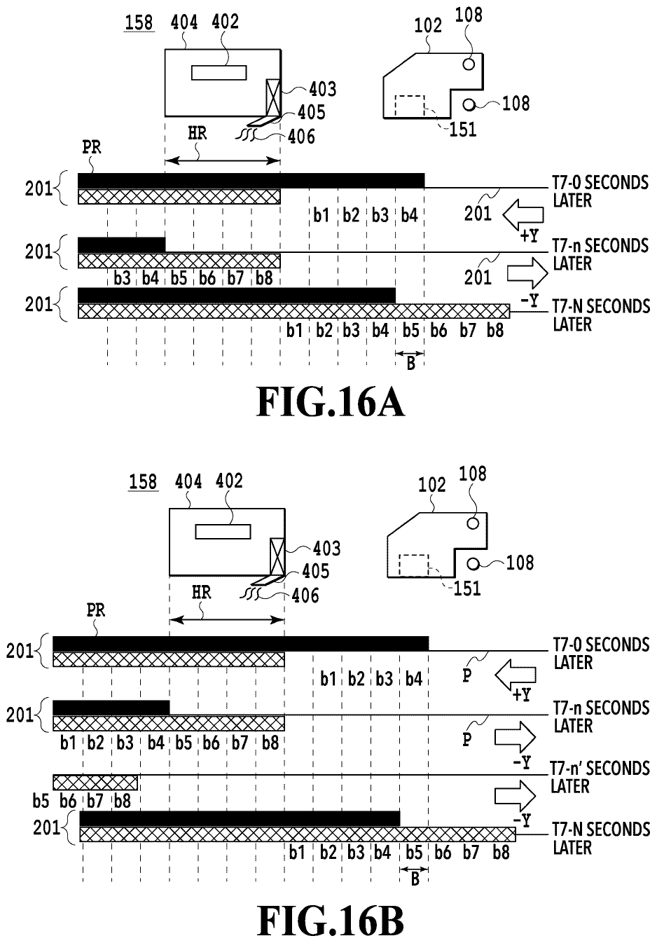

FIG. 16A is a diagram illustrating a comparative example where pullback control is not performed.

In pullback control, the cooling time required to sufficiently reduce the temperature of the drying heater 158 is obtained as a printing condition. The cooling time is set to a different value depending on the type of print medium, as well as the environmental temperature and the like. In pullback control, conveyance and reverse conveyance are performed according to the cooling time. To facilitate the understanding of the pullback control of the present embodiment, a comparative example of the pullback control will be described first.

As illustrated in FIG. 16A, a print medium 201 of this comparative example has a printed portion PR where ink is applied in a first print job. In FIG. 16A, the printed portion PR is indicated in black. Also, a portion heated at least once by the drying heater 158 is indicated by a diagonal checkered pattern.

In FIG. 16A, “T7-0 seconds later” indicates a time point upon completion of ink application to the print medium 201 in the print job, and “T7-n seconds later” indicates a time point upon completion of a fixing operation for the print medium 201 in the print job. In FIG. 16A, “T7-N seconds later” indicates a state where the print medium 201 is aligned with the print position of the print head 151 for the next print job.

As illustrated in FIG. 16A, in the configuration of this comparative example, after completion of the print operation of the preceding print job, the print medium 201 is conveyed in the conveyance direction at a predetermined conveyance speed until the printed portion PR passes directly below the drying heater 158. Accordingly, after the elapse of T7-n seconds, image fixing for the preceding print job is completed and the first print job is completed. In this comparative example, reverse conveyance is then performed until the region b5 reaches directly below the print head 151. This configuration can reduce the non-printed portion of the print medium 201, allowing the print medium 201 to be used without waste.

However, with this configuration, until the next print job is started, the same region HR of the print medium 201 remains directly below the drying heater 158 and continues to be affected by heat until the drying heater 158 cools. This increases the concern that scorching, deformation or the like occurs in the HR, reducing the image quality of the preceding print job. Furthermore, in a case where the processing waits until the next print job is received in the state of T7-N seconds later, there is an increased concern that scorching, deformation or the like occurs in part or all of the region HR.

Therefore, the printing apparatus 100 of the present embodiment executes pullback control to reduce deterioration in print quality.

FIG. 16B is a diagram illustrating the pullback control of the present embodiment.

As illustrated in FIG. 16B, the print medium 201 of the present embodiment has a printed portion PR where ink is applied in the preceding print job. In FIG. 16B, again, the printed portion PR is indicated in black. Also, a portion heated at least once by the drying heater 158 is indicated by a diagonal checkered pattern.

In FIG. 16B, “T7-0 seconds later” indicates a time point upon completion of ink application to the print medium 201 in the preceding print job, and “T7-n seconds later” indicates a time point upon completion of a fixing operation for that print job. For example, “T7-n seconds later” is the time point after the elapse of nine seconds from “T7-0 seconds later”.

Furthermore, “T7-n′ seconds later” indicates a time point upon completion of preliminary conveyance of the print medium 201 during the pullback control of the present embodiment. For example, “T7-n′ seconds later” is the time point after the elapse of five seconds from “T7-n seconds later”.

Furthermore, in FIG. 16B, “T7-N seconds later” indicates a time point upon completion of reverse conveyance of the print medium 201 during the pullback control of the present embodiment. As illustrated in FIG. 16B, in the configuration of the present embodiment, after the completion of the print operation of the preceding print job, the print medium 201 is conveyed at a predetermined conveyance speed until the printed portion PR passes directly below the drying heater 158. Accordingly, after the elapse of T7-n seconds, image fixing for the first print job is completed and the first print job is completed. Up to this point, the configuration of the present embodiment is the same as the configuration of the comparative example in FIG. 16A.

In the printing apparatus 100 of the present embodiment, after the completion of image fixing for a print job, the print medium 201 is further preliminarily conveyed along the conveyance direction until the temperature of the drying heater 158 sufficiently drops. For example, in a case where it takes five seconds for the temperature of the drying heater 158 to sufficiently drop, the print medium 201 is preliminarily conveyed for five seconds along the conveyance direction. After the completion of this preliminary conveyance, the print medium 201 is reversely conveyed in the reverse conveyance direction, and the start position of the next print job (for example, the region b5) is positioned directly below the print head 151.

In the example of FIG. 16B, the next print start portion of the print medium 201 is positioned directly below the print head 151 at the time point of T7-N seconds later. With this configuration, the region (indicated by the diagonal checkered pattern) of the print medium 201 heated by the drying heater 158 is larger than in the comparative example of FIG. 16A.

However, damage to each of these regions is less than in the comparative example of FIG. 16A. Therefore, the damage to the print medium 201 can be reduced. In other words, the configuration of the present embodiment can disperse the damage due to heating by the drying heater 158, compared to the configuration involving no pullback control.

Note that the conditions under which the drying heater 158 can be considered cooled vary depending on the temperature of the drying heater 158, the environmental temperature, and the like. Furthermore, depending on the type of print medium 201, it may be necessary to actively cool the drying heater 158, or there may be a case where the drying heater 158 does not need to be cooled at all. Therefore, in the printing apparatus 100 of the present embodiment, it is convenient to perform control to automatically reduce the damage by setting typical conditions under which the drying heater 158 can be considered cooled.

The printing apparatus 100 may also be configured so that the user can freely set these conditions and select either the warm-up control described in the second embodiment or the pullback control described in the third embodiment. This configuration allows the necessary control to be determined taking into account the time required for the print operation and the degree of damage to the print medium. This increases the degree of freedom in damage suppression control. For example, in this case, the damage to the print medium 201 can be further reduced by setting the conveyance speed up to T7-n′ seconds later to be equal to or higher than the conveyance speed up to T7-n seconds later.

Furthermore, by using the pullback control of the present embodiment only for print medium 201 particularly susceptible to damage from heat, the time required for pullback control can be shortened, which is efficient. Specific examples of the print medium 201 particularly susceptible to damage from heat include a resin film and the like.

It is also effective to relatively increase the conveyance speed and the reverse conveyance speed of the print medium 201 particularly susceptible to damage from heat.

### Fourth Embodiment

A configuration different from the configuration of the printing apparatus 100 of the above-described embodiments will be mainly described below. The same or corresponding components as those of the printing apparatus 100 of the above-described embodiments will be denoted by the same reference numerals, and description thereof will be omitted.

A printing apparatus 100 of the present embodiment will be described as being configured so that the user can set printing conditions such as those illustrated in FIG. 20. This configuration is effective in a case of more actively suppressing damage or a case where some damage can be determined to be no problem. In the present embodiment, the user presets specific printing conditions via an input/output device or the like.

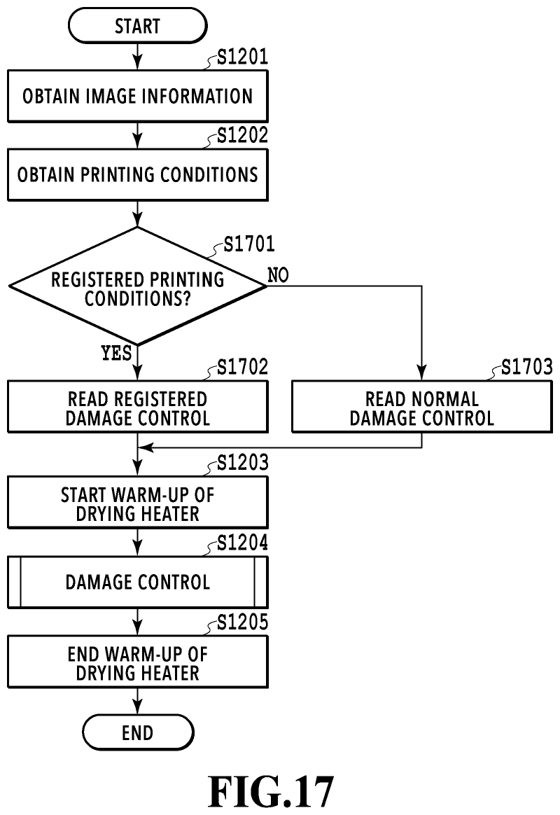

FIG. 17 is a flowchart illustrating an example of damage control in the present embodiment. Steps denoted by the same reference numerals as those in the flowchart of damage control described in FIG. 12 indicate that the same processing is performed.

As illustrated in FIG. 17, the CPU 128 of the present embodiment obtains printing conditions in S1202 and then executes processing of S1701.

In S1701, the CPU 128 determines whether the printing conditions corresponding to the image information obtained in S1201 are included in the printing conditions registered by the user. In a case where it is determined that the printing conditions are included in the printing conditions registered by the user, the CPU 128 executes processing of S1702. On the other hand, in a case where it is determined that the printing conditions are not included in the printing conditions registered by the user, the CPU 128 executes processing of S1703.

In S1702, the CPU 128 reads the specific printing conditions registered by the user from the memory 1001. The printing conditions include the respective times and conveyance speeds of the preliminary conveyance and reverse conveyance in damage control.

In S1703, the CPU 128 reads the normal printing conditions from the memory 1001. The processing from S1203 to S1205 is the same as that illustrated in FIG. 12.

Note that the printing conditions registered by the user may be a set of the type of print medium and the printing conditions corresponding to that type (number of scans, drying heater temperature, and the like). This configuration enables damage control suitable for the intended use of the printed material to be outputted, in addition to the pre-registered damage control.

### Modification of Fourth Embodiment

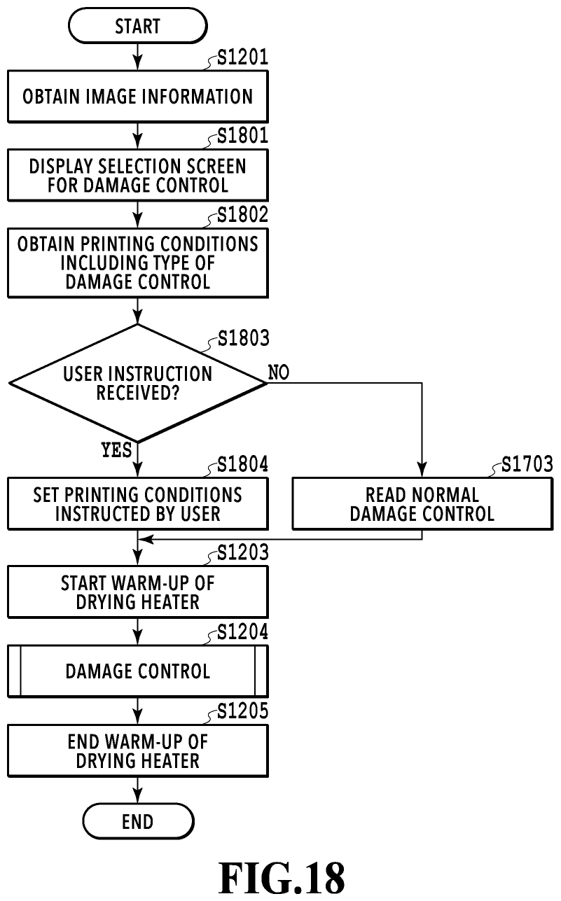

The specific printing conditions described above may be set by the user for each print job. FIG. 18 is a flowchart illustrating an example of damage control in a modification of the fourth embodiment.

As illustrated in FIG. 18, the CPU 128 of the present embodiment executes processing of S1801 after completing the processing of S1201.

In S1801, the CPU 128 displays a damage control selection screen for the image information obtained in S1201 on a panel (not illustrated) of the input/output device 162 (see FIG. 10). Using the selection screen on the panel, which corresponds to a receiving unit, the user can enter his/her preferred instructions regarding damage control.

In S1802, the CPU 128 obtains an instruction regarding the printing conditions inputted by the user using the screen displayed in S1801. These printing conditions include damage control details. After completing the processing of S1802, the CPU 128 executes processing of S1803.

In S1803, the CPU 128 determines whether the instruction regarding the printing conditions inputted by the user is received. In a case where it is determined that the instruction is received, the CPU 128 executes processing of S1804. On the other hand, in a case where it is determined that the instruction is not received, the CPU 128 executes the processing of S1703.

In S1804, the CPU 128 sets printing conditions, including the damage control instructed by the user. In S1703, the CPU 128 reads the normal printing conditions from the memory 1001. The subsequent processing is the same as that illustrated in FIG. 12, and thus description thereof will be omitted.

The flowchart of this modification has been described above.

This modification also makes it possible to perform damage control suitable for the intended use of the printed material to be outputted, in addition to the pre-registered damage control.

The effects of the present embodiment will be described with reference to FIG. 20. Here, it is assumed that the environmental temperature is 25° C., the type of the print medium is “IJ1220-10”, and Example 7 is registered in the memory as the normal printing conditions. Under these conditions, in a case where the user considers that “size variation in print medium and the like are not considered problematic as long as print operations are not affected thereby”, the user may set the conveyance speed of the preliminary conveyance and reverse conveyance to be slower than normal, as in Example 8, for example. In this way, it is useful to be able to arbitrarily select the content of the damage control according to the user's preference.

### Example of Materials to be Used

Ink and materials of print media that can be used in the present disclosure will be described below. However, the technical scope of the present disclosure is not limited in any way by the following examples without departing from the scope of the present disclosure. As for the amount of components, “parts” and “%” are based on mass unless otherwise specified.

In the present disclosure, water-based ink for inkjet printing is simply referred to as “ink”. The following physical property values are values at room temperature (25° C.) unless otherwise specified. “(Meth)acrylic acid” and “(meth)acrylate” refer to “acrylic acid, methacrylic acid” and “acrylate, methacrylate”, respectively. The ink used in this example is prepared as follows. In the following evaluation, “A” to “C” are considered acceptable levels, and “D” is considered unacceptable.

### Preparation of Aqueous Dispersion of Resin Particles

74.0 parts of ion-exchanged water and 0.2 parts of potassium persulfate were mixed in a four-neck flask equipped with a stirrer, reflux condenser, and nitrogen gas inlet tube. An emulsion was also prepared by mixing 24.0 parts of ethyl methacrylate, 1.5 parts of methacrylic acid, and 0.3 parts of reactive surfactant (trade name: “Aqualon KH-05” manufactured by Dai-ichi Kogyo Seiyaku Co., Ltd.). Under a nitrogen atmosphere, the prepared emulsion was instilled into the four-neck flask over one hour, and a polymerization reaction was carried out for two hours with stirring at 80° C. After cooling to 25° C., ion-exchanged water and an aqueous solution containing potassium hydroxide in an amount equimolar to the acid value of the resin particles were added to prepare an aqueous dispersion of resin particles with a resin particle content (solid content) of 25.0%.

### Preparation of Pigment Dispersion

A styrene-ethyl acrylate-acrylic acid copolymer (Resin 1) with an acid value of 150 mgKOH/g and a weight-average molecular weight of 8,000 was prepared. 20.0 parts of Resin 1 were neutralized with potassium hydroxide in an amount equimolar to the acid value, and an appropriate amount of pure water was added to prepare an aqueous solution of Resin 1 with a resin content (solid content) of 20.0%. A mixture was obtained by mixing 2.0 parts of pigment (carbon black), 15.0 parts of the aqueous solution of Resin 1, and 75.0 parts of pure water. The resulting mixture and 200 parts of 0.3 mm diameter zirconia beads were placed in a batch-type vertical sand mill (manufactured by Imex) and dispersed for five hours while cooling with water. After coarse particles were removed by centrifugal separation, the mixture was filtered under pressure using a cellulose acetate filter (manufactured by Advantec) with a pore size of 3.0 μm to prepare a pigment dispersion having a pigment content of 2.0% and a resin dispersant (Resin 1) content of 3.0%.

### Preparation of Ink

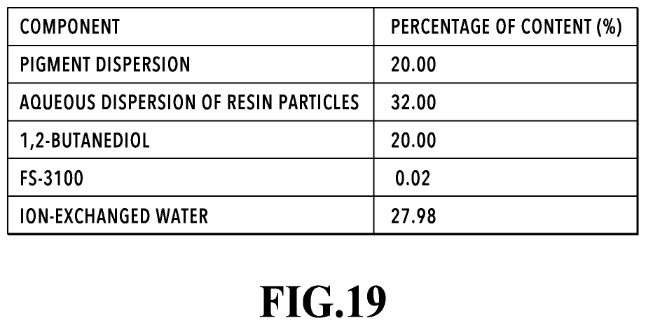

FIG. 19 is a table illustrating the ink composition.

The components (unit: %) illustrated in the table of FIG. 19 were mixed and thoroughly stirred, and then pressure filtered through a cellulose acetate filter (manufactured by Advantec) with a pore size of 3.0 μm to prepare each ink. The number next to polyethylene glycol indicates the number average molecular weight of polyethylene glycol. “FS-3100” is the trade name of a surfactant manufactured by Chemourst.

### Heat Damage Impact Assessment

Under the printing conditions illustrated in FIG. 20, the heat resistance of the print medium was classified based on the following criteria.

A 1-meter-long print medium was placed in an oven heated to a predetermined temperature (80° C. or 90° C.) for a predetermined period of time (80 seconds). The heat resistance of the print medium was classified based on whether the size variation before and after the placement in the oven was within a small range (within ±1%). In this example, the following three kinds of sheet were used as the representative sheet for heat resistance classification.
IJ1220-10 (3M Japan Ltd.)
SV-2300M (FDC JAPAN CO., LTD.)
LLSPSR5135 (SAKURAI CO., LTD.)

The heat resistance was also categorized into three levels: strong, medium, and weak.
Strong: Print medium group with high heat resistance (deformation within reference range after 80 seconds at 90° C.).
Medium: Print medium group with a certain degree of heat resistance secured (deformation exceeds reference after 80 seconds at 90° C., but is within reference range after 80 seconds at 80° C.).
Weak: Print medium with low heat resistance (deformation outside reference range after 80 seconds at 80° C.).

An assessment method involved controlling sheet conveyance so that post-printing fixing period (time required for passing through the drying heater) was within the predetermined drying time illustrated in the table, and assessing whether size variation falls within the reference range with and without this control. Assessment ranking of the size variation was as follows.
A: The difference was within the measurement error.
B: The difference was within ±1%.
C: The difference was greater than ±1%, but no head rubbing nor jamming occurred during print operation.
D: The difference was greater than ±1%, and head rubbing or jamming occurred during print operation.

Furthermore, the drying heater temperature and airflow were controlled so that the maximum temperature as a result of applying heat to the print media by the drying heater would be the drying temperature illustrated in the table.

The effects of the second embodiment will be described below with reference to FIG. 20. In FIG. 20, Examples 1 to 12 illustrate cases where damage control is performed during warm-up. Wait1 and Wait2 in FIG. 20 correspond to preliminary conveyance time and reverse conveyance time, respectively, in damage control.

Comparative Examples 1, 2, and 3 illustrate cases where damage control is not performed during warm-up. For example, SV-2300M having the lowest heat resistance is ranked as D, since the size variation is large even with the fixation at 80° C. (Comparative Example 1). However, IJ1220-10 having high heat resistance is ranked as B (not illustrated), since the size variation is small with the fixation at 80° C., but is ranked as D with the fixation temperature raised to 100° C. (Comparative Example 3).

Examples 1 to 4 illustrate cases where damage control is applied to Comparative Examples 1, 2, and 3. Using damage control can minimize the size variation regardless of the type of print medium.

Furthermore, as mentioned above, in a case where the print media are different with the same fixation temperature, the size variation differs depending on the difference in heat resistance between the print media. In this case, using damage control is particularly effective for the print media with weak heat resistance, as in Comparative Example 1. In this way, by switching presence or absence of damage control based on heat resistance information, in particular, on the print medium, the size variation in the print medium can be suppressed.

In addition, in terms of damage, increasing the conveyance time or conveyance speed to increase the conveyance amount can further enhance the effect of avoiding heat damage. This can be explained by the fact that the time per unit area exposed to heat damage inside the drying heater is reduced. For example, comparing Examples 1 and 2, which differ only in the conveyance speeds of the preliminary conveyance and reverse conveyance under the same conditions for the same print medium, it can be seen that Example 2 with a higher conveyance speed suppresses size variation and is more effective at avoiding heat damage.

The damage control in FIG. 20 illustrates a method for controlling the conveyance time and conveyance speed. In this case, in a case where the sum of the preliminary conveyance time (Wait1) and the reverse conveyance time (Wait2) is equal to or greater than the warm-up time of the drying heater, the conveyance continues during warm-up. However, in a case where the sum of the preliminary conveyance time (Wait1) and the reverse conveyance time (Wait2) is shorter than the warm-up time of the drying heater, the conveyance stops during warm-up, thereby reducing the effect of avoiding heat damage. For example, comparing Examples 4 and 5, it can be seen that the effect of avoiding heat damage is weakened in Example 5 where the conveyance is stopped for 40 seconds (130−(45+45)=40).

Furthermore, differences in environmental temperature of printing can affect the warm-up time. This phenomenon occurs more significantly in a case where the blast fan inside the drying heater has a mechanism for taking in outside air. For example, in Examples 11 and 12 where the environmental temperature is 15° C., the warm-up time is 150 seconds, which is longer than in a case where the environmental temperature is 25° C. Therefore, in Example 12 (130 seconds) where the sum of the preliminary conveyance time and the reverse conveyance time is shorter than the warm-up time (150 seconds), the conveyance stops before the warm-up ends, resulting in weakened ability to avoid heat damage. In other words, as in Example 11, it is preferable to control the sum of the preliminary conveyance time and the reverse conveyance time (75+75=150 seconds) of the drying heater warm-up control to be equal to or greater than the warm-up time.

Next, the effect of the third embodiment will be described with reference to FIG. 21. In FIG. 21, Examples 13 to 24 illustrate cases where pullback control is performed without damage control. Wait3 and Wait4 in FIG. 21 correspond to the preliminary conveyance time and the reverse conveyance time in pullback control, respectively.

Examples 13 to 17 illustrate cases where pullback control is applied to Comparative Examples 1 to 3 in FIG. 20. Using pullback control can minimize the size variation regardless of the type of print medium.

Furthermore, as with the second embodiment, increasing the conveyance amount can further enhance the effect of avoiding heat damage. For example, it can be seen that Example 14 where the conveyance amount (conveyance speed) is increased even under the same conditions as Example 13 is more effective at suppressing the size variation.

The pullback control in FIG. 21 illustrates a method for controlling the conveyance time and conveyance speed. In this case, in a case where the sum of the preliminary conveyance time (Wait3) and the reverse conveyance time (Wait4) is equal to or greater than the cooling time of the drying heater, the conveyance continues during cooling. However, in a case where the sum of the preliminary conveyance time (Wait3) and the reverse conveyance time (Wait4) is shorter than the cooling time of the drying heater, the conveyance stops in the middle of cooling, reducing the effect of avoiding heat damage.

For example, comparing Examples 16 and 17, the effect of avoiding heat damage is weakened in Example 17 where the conveyance is stopped for about 50 seconds (300−(125+125)=50).

Furthermore, differences in environmental temperature of printing can affect the cooling time. This phenomenon occurs more significantly in a case where the blast fan inside the drying heater has a mechanism for taking in outside air. For example, in Example 23 where the environmental temperature is 35° C., the cooling time is longer than in Example 22 where the environmental temperature is 25° C., and therefore the preliminary conveyance time and the reverse conveyance time are also longer.

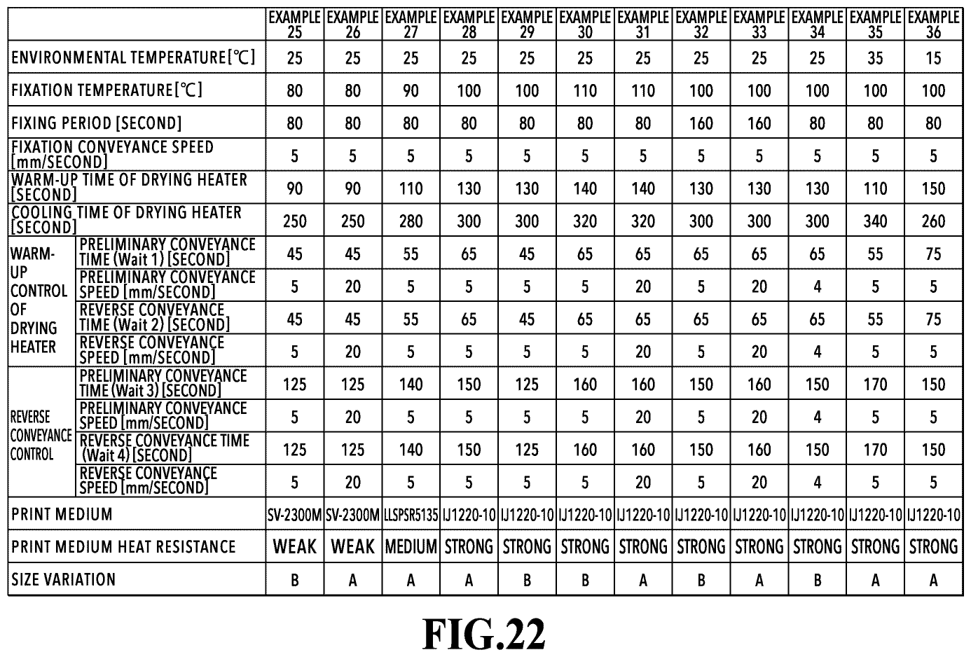

Next, with reference to FIG. 22, the effect of performing both the damage control of the second embodiment and the pullback control of the third embodiment will be described. In FIG. 22, Examples 25 to 36 illustrate cases where both damage control and pullback control are performed. The meaning of each item is the same as in FIG. 21 described above, and thus description thereof will be omitted.

By employing both damage control and pullback control, size variations can be further minimized for both heat-sensitive and heat-resistant print media.

By using both warm-up control and pullback control, significant effects can be achieved. Specifically, significant effects can be achieved by appropriately adjusting Wait1, Wait2, Wait3, and Wait4.

### Other Embodiments

The above embodiments have been described assuming a case where a preceding print job and a subsequent print job are received consecutively within a relatively short period of time. However, the technology of the present disclosure is also applicable to a configuration in which a relatively long period of time elapses between these print jobs.

Furthermore, the technology of the present disclosure is applicable, for example, whether the set temperature of the drying heater for the subsequent print job is higher or lower than that of the preceding print job. That is, the technology of the present disclosure is applicable to a case where the warm-up time is required to raise the temperature of the drying heater and a case where the cooling time is required.

Furthermore, in a case where the set temperature for the preceding print job is the same as the set temperature for the subsequent print job, the warm-up time for the drying heater is usually no longer necessary, and the print operation for the subsequent print job can start immediately after the preceding print job is completed. However, the technology of the present disclosure works effectively in a case where the subsequent print job is received some time after the preceding print job is completed.

In the above embodiments, it is assumed that the print medium is cooled by natural heat dissipation. However, the printing apparatus may also include a cooling device (for example, a cooling fan (not illustrated)) for cooling the print medium heated by the drying heater, and a cooling driver (not illustrated) for driving the cooling device. In a case where the printing apparatus includes the cooling device, the CPU controls driving of the cooling driver. With this configuration, the print medium can be cooled more quickly than in a case where the print medium is left to cool naturally. In other words, the print medium can be cooled regardless of the presence or absence of the cooling device.

In the above embodiments, ink containing a color material is used as the liquid, but the liquid that can be used for the technology of the present disclosure is not limited to ink. Besides the ink, various printing liquids can also be used, including treatment liquids or the like used for the purpose of improving ink fixation on the print medium, reducing gloss unevenness, and improving abrasion resistance.

Embodiment(s) of the present disclosure can also be realized by a computer of a system or apparatus that reads out and executes computer executable instructions (for example, one or more programs) recorded on a storage medium (which may also be referred to more fully as a ‘non-transitory computer-readable storage medium’) to perform the functions of one or more of the above-described embodiment(s) and/or that includes one or more circuits (for example, application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (for example, central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The printing apparatus of the present disclosure allows for appropriate use of roll sheet.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-188386, filed Oct. 25, 2024, and Japanese Patent Application No. 2025-110754 filed Jun. 30, 2025, which are hereby incorporated by reference herein in their entirety.

What is claimed is:

1. A printing apparatus comprising:
a conveyance unit configured to convey roll sheet in a conveyance direction;
a printing unit configured to print an image by ejecting a liquid onto the roll sheet conveyed by the conveyance unit;
a drying unit provided downstream of the printing unit in the conveyance direction and configured to heat and dry a region of the roll sheet where the image is printed by the printing unit; and
a control unit configured to control driving of the conveyance unit, driving of the printing unit, and driving of the drying unit to execute a second print job after a first print job is completed, wherein
the control unit preliminarily conveys the roll sheet in the conveyance direction after the first print job is completed, and
the control unit reversely conveys the roll sheet in a direction opposite to the conveyance direction in a case where, during the preliminary conveyance, a temperature of the roll sheet in the region exposed to heat from the drying unit meets a predetermined condition for executing the second print job.

2. The printing apparatus according to claim 1, wherein
the predetermined condition is that the temperature of the roll sheet reaches a set temperature for the second print job after a predetermined period of time.

3. The printing apparatus according to claim 1, further comprising:
a detection unit configured to detect the temperature of the roll sheet in the region heated by the drying unit, wherein
the control unit determines whether the predetermined condition is met, based on the temperature detected by the detection unit.

4. The printing apparatus according to claim 1, further comprising;
a unit configured to obtain a surrounding environmental temperature, wherein
the control unit determines whether the predetermined condition is met, based on the environmental temperature.

5. The printing apparatus according to claim 1, further comprising;
a unit configured to obtain a surrounding environmental humidity, wherein
the control unit determines whether the predetermined condition is met, based on the environmental humidity.

6. The printing apparatus according to claim 1, wherein
the control unit starts printing an image of the second print job by the printing unit, after the reverse conveyance is performed to align a region of the roll sheet in which the image of the second print job is to be printed with a position where printing can be performed by the printing unit.

7. The printing apparatus according to claim 1, wherein
the control unit compares a remaining time until the set temperature for the second print job is reached with a time required to reversely convey the region of the roll sheet in which the image of the second print job is to be printed to a position where printing can be performed by the printing unit at a predetermined conveyance speed,
in a case where the required time is shorter than the remaining time, the control unit performs the reverse conveyance at the predetermined conveyance speed, and
in a case where the required time is longer than the remaining time, the control unit performs the reverse conveyance at a conveyance speed faster than the predetermined conveyance speed.

8. The printing apparatus according to claim 7, wherein
the set temperature for the second print job is lower than the set temperature for the first print job, and
the remaining time is a time required for the temperature of the roll sheet to cool to a predetermined temperature.

9. The printing apparatus according to claim 1, wherein
the control unit controls an image of the first print job and an image of the second print job to be continuous in the conveyance direction without any unnecessary non-printed portions between the images.

10. The printing apparatus according to claim 1, wherein
the control unit switches the conveyance speed for the preliminary conveyance to a faster conveyance speed, in a case where it is determined that the temperature of the roll sheet reaches the set temperature for executing the second print job after a predetermined period of time during the preliminary conveyance.

11. The printing apparatus according to claim 1, wherein
in a case where a setting is made to use a non-printed portion heated by the drying unit after the first print job is completed, as a start position of the second print job,
the control unit performs the preliminary conveyance and the reverse conveyance of the roll sheet,
in a case where no setting is made to use the non-printed portion heated by the drying unit after the first print job is completed, as the start position of the second print job,
the control unit does not perform the preliminary conveyance and the reverse conveyance of the roll sheet.

12. The printing apparatus according to claim 1, wherein
the liquid is ink containing a thermosetting component.

13. A control method for a printing apparatus including
a conveyance unit configured to convey roll sheet in a conveyance direction,
a printing unit configured to print an image by ejecting a liquid onto the roll sheet conveyed by the conveyance unit,
a drying unit provided downstream of the printing unit in the conveyance direction and configured to heat and dry a region of the roll sheet where the image is printed by the printing unit, and
a control unit configured to control driving of the conveyance unit, driving of the printing unit, and driving of the drying unit to execute a second print job after a first print job is completed,
the control method comprising:
preliminarily conveying the roll sheet in the conveyance direction after the first print job is completed; and
reversely conveying the roll sheet in a direction opposite to the conveyance direction in a case where, during the preliminary conveyance, a temperature of the region of the roll sheet exposed to heat from the drying unit meets a predetermined condition for executing the second print job.

14. A printing apparatus comprising:
a conveyance unit configured to convey roll sheet in a conveyance direction;
a printing unit configured to print an image by ejecting a liquid onto the roll sheet conveyed by the conveyance unit;
a drying unit provided downstream of the printing unit in the conveyance direction and configured to heat and dry a region of the roll sheet where the image is printed by the printing unit; and
a control unit configured to control driving of the conveyance unit, driving of the printing unit, and driving of the drying unit to execute a print job, wherein
upon receipt of the print job, the control unit preliminarily conveys the roll sheet in the conveyance direction before starting a print operation of the print job,
the control unit reversely conveys the roll sheet in a reverse conveyance direction opposite to the conveyance direction after the preliminarily conveyance is complete, and
the control unit starts the print operation of the print job after the reverse conveyance is complete.

15. The printing apparatus according to claim 14, wherein
the control unit preliminarily conveys the roll sheet again in the conveyance direction after the print operation of the print job is completed, and then reversely conveys the roll sheet again in the reverse conveyance direction after the preliminary conveyance performed again is completed.

16. A printing apparatus comprising:
a conveyance unit configured to convey roll sheet in a conveyance direction;
a printing unit configured to print an image by ejecting a liquid onto the roll sheet conveyed by the conveyance unit;
a drying unit provided downstream of the printing unit in the conveyance direction and configured to heat and dry a region of the roll sheet where the image is printed by the printing unit; and
a control unit configured to control driving of the conveyance unit, driving of the printing unit, and driving of the drying unit to execute a print job, wherein
the control unit preliminarily conveys the roll sheet in the conveyance direction after a print operation of the print job is completed, and
the control unit reversely conveys the roll sheet in a reverse conveyance direction opposite to the conveyance direction after the preliminarily conveyance is complete.

17. The printing apparatus according to claim 16, wherein
the control unit starts a print operation of a print job received subsequent to the print job after the reverse conveyance is completed.

18. The printing apparatus according to claim 14, wherein
the control unit changes a set temperature of the drying unit according to a type of the roll sheet.

19. The printing apparatus according to claim 18, wherein
the control unit sets a conveyance speed during the preliminary conveyance and the reverse conveyance to a first conveyance speed in a case where the set temperature is a first temperature, and
the control unit sets the conveyance speed during the preliminary conveyance and the reverse conveyance to a second conveyance speed higher than the first conveyance speed in a case where the set temperature is a second temperature higher than the first temperature.

20. The printing apparatus according to claim 14, further comprising:
a receiving unit configured to receive, from a user, settings for whether to perform the preliminary conveyance and the reverse conveyance, the set temperature of the drying unit, the speed of the preliminary conveyance, and the speed of the reverse conveyance.

21. A control method for a printing apparatus including
a conveyance unit configured to convey roll sheet in a conveyance direction,
a printing unit configured to print an image by ejecting a liquid onto the roll sheet conveyed by the conveyance unit, and
a drying unit provided downstream of the printing unit in the conveyance direction and configured to heat and dry a region of the roll sheet where the image is printed by the printing unit,
the control method comprising:
preliminarily conveying the roll sheet in the conveyance direction, upon receipt of a print job, before starting a print operation of the print job;
reversely conveying the roll sheet in a reverse conveyance direction opposite to the conveyance direction after the preliminarily conveyance is complete, and
starting the print operation of the print job after the reverse conveyance is complete.

22. A control method for a printing apparatus including
a conveyance unit configured to convey roll sheet in a conveyance direction,
a printing unit configured to print an image by ejecting a liquid onto the roll sheet conveyed by the conveyance unit, and
a drying unit provided downstream of the printing unit in the conveyance direction and configured to heat and dry a region of the roll sheet where the image is printed by the printing unit,
the control method comprising:
preliminarily conveying the roll sheet in the conveyance direction after a print operation of a print job is completed; and
reversely conveying the roll sheet in a reverse conveyance direction opposite to the conveyance direction after the preliminary conveyance is completed.
